(19) United States
(12) Patent Application Publication
(10) Pub. No.: US 2025/0271286 A1
(43) Pub. Date: Aug. 28, 2025

(54) HIGH PRECISION ANGULAR MEASUREMENT SYSTEM

(71) Applicant: Analog Devices International Unlimited Company, Limerick (IE)

(72) Inventors: Jochen Schmitt, Biedenkopf (DE); Patrick Kirby, Limerick (IE); Luke George Vickery, Raheen (IE); Christian Nau, Marburg (DE); Enda Nicholl, Kilmallock (IE); Shane O’Meara, Ballina (IE)

(73) Assignee: Analog Devices International Unlimited Company, Limerick (IE)

(21) Appl. No.: 19/057,624

(22) Filed: Feb. 19, 2025

Related U.S. Application Data
(60) Provisional application No. 63/557,035, filed on Feb. 23, 2024.

(51) Int. Cl. G01D 5/245; H02K 11/215

(52) U.S. Cl. CPC G01D 5/2452; H02K 11/215

(57) ABSTRACT

A measurement system and method of manufacture can include: a magnet mounted on a rotatable shaft; a first magnetic sensing device for detecting a first magnetic field from the magnet, the first magnetic sensing device comprising: an angle sensor configured to detect an orientation of the first magnetic field and a magnetic multi-turn sensor configured to detect a number of turns of the first magnetic field; and a second magnetic sensing device comprising a magnetic target mounted on the rotatable shaft and an incremental sensor configured to detect a second magnetic field, the magnetic target comprises a track for inducing a change in the second magnetic field.

### TECHNICAL FIELD

This disclosure relates to angular measurement, more particularly to high precision angular measurement including powerless multi-turn capability.

### BACKGROUND

Massive trends toward automation are underway in many industries, including manufacturing, health care, and automotive. This automation relies heavily on precise control rotational movement, for which accurate measurement of position is critical.

Magnetic single turn sensors and multi-turn sensors are commonly used in applications where there is a need to monitor both the number of times a device has been turned and its precise angular position. Magnetic multi-turn sensors and single turn sensors typically use magnetoresistive elements that are sensitive to an applied external magnetic field. The resistance of the magnetoresistive elements in multi-turn sensors can be changed by rotating a magnetic field within the vicinity of the sensor.

Variations in the resistance of the magnetoresistive elements can be tracked to determine the number of turns in the magnetic field, which can be translated to a number of turns in the device being monitored. Similarly, variations in the resistance of the magnetoresistive elements in single turn sensors can be tracked to determine the magnetic field angle, which can be translated to the angular position of the device being monitored.

As an offshoot of the electronics industry, angular measurement systems have come under ever-increasing commercial competitive pressures, along with growing consumer expectations and the diminishing opportunities for meaningful product differentiation. Current roadmaps for next generation products target greater functionality and greater accuracy.

One known challenge in automation is the need to re-home or re-initialize electric motors if a power failure event occurs. This re-initialization can cost many hours, and can result in scrap product if the power failure occurs when a factory tool is loaded.

Another challenge with implementing rotation measurement systems is in systems that utilize gear boxes to transfer multiple rotation into one rotation and thereby measure multi-rotations. However, these methods are big and bulky. There are also systems using battery powered single turn sensors to count turns. But these systems fail to provide a real powerless solution.

Thus, a need still remains for an angular measurement system with greater accuracy and power off capabilities. Solutions to these problems have been long sought but prior developments have not taught or suggested any complete solution and, thus, solutions to these problems have long eluded those skilled in the art.

### BRIEF DESCRIPTION OF DRAWINGS

The high precision angular measurement system, hereinafter referred to as the measurement system, is illustrated in the figures of the accompanying drawings which are meant to be exemplary and not limiting, in which like reference numerals are intended to refer to like components, and in which:

FIG. 1 is a side view of the measurement system in a first embodiment.

FIG. 2 is an exploded isometric view of the measurement system in a second embodiment.

FIG. 3 is a side view of the measurement system in a second embodiment of FIG. 2.

FIG. 4 is an exploded isometric view of the measurement system in a third embodiment.

FIG. 5 is a side view of an end shaft magnet for any embodiment of the measurement system.

FIG. 6 is a side view of an end shaft magnet for any embodiment of the measurement system.

FIG. 7 is a side view of an end shaft magnet for any embodiment of the measurement system.

FIG. 8 is a side view of an end shaft magnet for any embodiment of the measurement system.

FIG. 9 is an isometric view of an end shaft magnet for any embodiment of the measurement system.

FIG. 10 is an isometric view of an end shaft magnet for any embodiment of the measurement system.

FIG. 11 is an isometric view of an end shaft magnet for any embodiment of the measurement system.

FIG. 12 is a side view of the measurement system in a fourth embodiment.

FIG. 13 is a side view of the measurement system in a fifth embodiment.

FIG. 14 is a side view of the measurement system in a sixth embodiment.

FIG. 15 is a side view of the measurement system in a seventh embodiment.

FIG. 16 is a flow chart for operating the measurement system.

FIG. 17 is a side view of the measurement system in an eighth embodiment.

FIG. 18 is a side view of the measurement system in a ninth embodiment.

FIG. 19 is an isometric view of the measurement system in a tenth embodiment.

FIG. 20 is a cross-sectional view of the measurement system in the tenth embodiment of FIG. 19.

FIG. 21 is a cross-sectional view of the measurement system in the tenth embodiment of FIG. 19 after an over molding phase of manufacture.

FIG. 22 is an isometric view of the measurement system in an eleventh embodiment.

FIG. 23 is a cross-sectional view of the measurement system in the eleventh embodiment of FIG. 22.

FIG. 24 is a side view of the measurement system in a twelfth embodiment.

FIG. 25 is a side view of the measurement system in a thirteenth embodiment.

FIG. 26 is a side view of the measurement system in a fourteenth embodiment.

FIG. 27 is a side view of the measurement system in a fifteenth embodiment.

FIG. 28 is a side view of the measurement system in a sixteenth embodiment.

FIG. 29 is a side view of the measurement system in a seventeenth embodiment.

FIG. 30 is a side view of the measurement system in an eighteenth embodiment.

FIG. 31 is a side view of the measurement system in a nineteenth embodiment.

FIG. 32 is a block diagram of the measurement system in a rotary application.

FIG. 33 is a block diagram of the measurement system in a first rotary to linear application.

FIG. 34 is a block diagram of the measurement system in a second rotary to linear application.

FIG. 35 is a control flow for manufacturing the measurement system.

FIG. 36 is a magnetic multi-turn sensor for an embodiment of the measurement system.

### DETAILED DESCRIPTION

In the following description, reference is made to the accompanying drawings that form a part hereof, and in which are shown by way of illustration, embodiments in which the measurement system may be practiced. It is to be understood that other embodiments may be utilized and structural changes may be made without departing from the scope of the measurement system.

When features, aspects, or embodiments of the measurement system are described in terms of steps of a process, an operation, a control flow, or a flow chart, it is to be understood that the steps can be combined, performed in a different order, deleted, or include additional steps without departing from the measurement system as described herein.

The measurement system is described in sufficient detail to enable those skilled in the art to make and use the measurement system and provide numerous specific details to give a thorough understanding of the measurement system; however, it will be apparent that the measurement system may be practiced without these specific details.

In order to avoid obscuring the measurement system, some well-known system configurations and descriptions are not disclosed in detail. Likewise, the drawings showing embodiments of the system are semi-diagrammatic and not to scale and, particularly, some of the dimensions are for the clarity of presentation and are shown greatly exaggerated in the drawing FIGs. As used herein, the term “couple” as in “coupling” or “coupled” means direct or indirect physical contact between elements.

For clarity, the figures are depicted with symbols based on MPEP 608.02IX. DRAWING SYMBOLS when depicting polarity of magnetic elements. Particularly, slanted symbols indicating green can indicate north magnetic polarity while horizontal and vertical symbols indicating blue and red, respectively, can indicate south magnetic polarity.

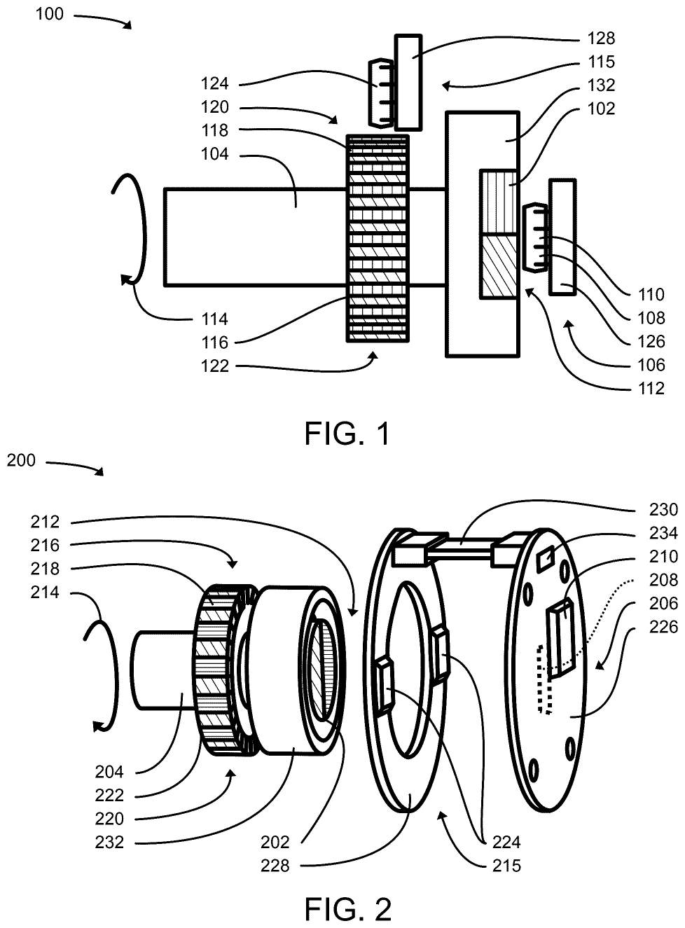

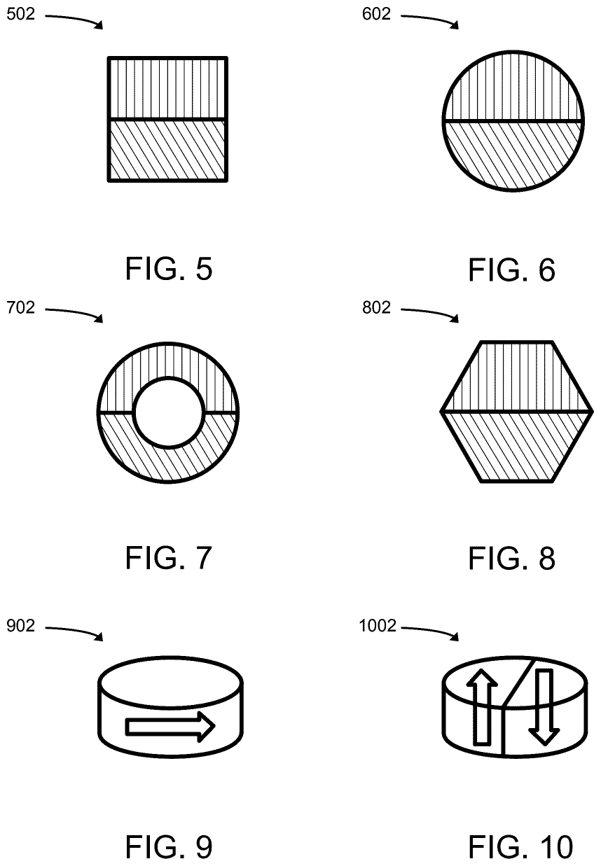

Referring now to FIG. 1, therein is shown a side view of the measurement system 100 in a first embodiment. The measurement system 100 can be a magnetic sensor system, comprising a magnet 102 mounted on a rotatable shaft 104. The magnet 102 can, for example, be the end of shaft magnets of FIGS. 5-11.

The measurement system 100 can further include a first magnetic sensing device 106 in a vicinity of the magnet 102, the first magnetic sensing device 106 can comprise an angle sensor 108 and a magnetic multi-turn sensor 110. The angle sensor 108 can be configured to detect an orientation of a first magnetic field 112 generated by the magnet 102 as the rotatable shaft 104 is rotated.

The magnetic multi-turn sensor 110 can be configured to detect a number of turns 114 of the first magnetic field 112 caused by the magnet 102 rotating on the rotatable shaft 104. Both the angle sensor 108 and the magnetic multi-turn sensor 110 are configured to read the first magnetic field 112.

With both the magnetic multi-turn sensor 110 and the angle sensor 108 within the first magnetic sensing device 106, a wide angle-range can be read and detected. For instance, the angle sensor 108 can determine angles between 0 and 360 degrees, while the multi-turn sensor could, for example, count to 48 turns and provide a range of 48 times 360 degrees or 17280 degrees of measurement.

Particularly, the magnetic multi-turn sensor 110 and angle sensor 108 typically use magnetoresistive elements that are sensitive to an applied external magnetic field, such as the first magnetic field 112. The resistance of the magnetoresistive elements in the magnetic multi-turn sensor 110 can be changed by rotating the first magnetic field 112 within the vicinity of the magnetic multi-turn sensor 110.

Variations in the resistance of the magnetoresistive elements can be tracked to determine the number of turns in the first magnetic field 112, which can be translated to a number of turns in the device being monitored. The variations of resistance in the magnetoresistive elements is changed by the magnet 102 even when the measurement system 100 is powered down. The magnetic multi-turn sensor 110 can be read when power is restored to determine the number of turns 114 the rotatable shaft 104 turned during power off or power on conditions.

Similarly, variations in the resistance of the magnetoresistive elements in the angle sensor 108 can be tracked to determine the magnetic field angle, which can be translated to the angular position of the rotatable shaft 104. The angle sensor 108 could be any kind of angle sensor including giant magnetoresistance (GMR) sensors, tunnel magnetoresistance (TMR) sensors, or anisotropic magneto resistance (AMR) sensors, which are collectively referred to collectively as xMR sensors.

The angle sensor 108 could also be a hall based sensor. It is further contemplated that the first magnetic sensing device 106 can include a quadrant detector formed of at least two magnetoresistive elements.

The magnetoresistive elements can preferably be giant magnetoresistive elements, which may be integrated to the die of the magnetic multi-turn sensor 110 or provided on a separate die within the packaging encapsulation of the first magnetic sensing device 106. The magnetoresistive elements are configured to provide a unique combination of resistance states for each quadrant of direction of the first magnetic field 112.

This quadrant information can then be used to remedy any ambiguities in the measurement of the magnetic multi-turn sensor 110 without needing 360° absolute angle information from the angle sensor 108. To increase the resolution and precision of the measurements of the first magnetic sensing device 106, a second magnetic sensing device 115 can be included.

The second magnetic sensing device 115 consists of a magnetic target 116 or disk such as a pole-ring, a soft magnetic gear, a soft magnetic disk with holes, or a pole disk. The second magnetic sensing device 115 can detect the magnetic field change caused by the magnetic target 116 as it is rotated by the rotatable shaft 104.

The magnetic target 116 can for example be the magnetic targets of FIGS. 12-15. The magnetic target 116 can comprise at least one track 118 for inducing a change in a second magnetic field 120 generated by the magnetic target 116.

The tracks 118 can be magnetic areas formed from a plurality of curved magnet segments distributed around a circumference 122 of the magnetic target 116. The second magnetic sensing device 115 can include an incremental sensor 124 configured to detect changes in the second magnetic field 120 induced by the tracks 118 as the rotatable shaft 104 is rotated.

Together, the first magnetic sensing device 106 and the second magnetic sensing device 115 provide a higher level of precision and resolution. That is, the magnetic multi-turn sensor 110 counts the number of turns 114 of the magnet 102 on the rotatable shaft 104 from the first magnetic field 112 while the angle sensor 108 measures the absolute angle of the rotatable shaft 104 from the first magnetic field 112.

The measurements made by the magnetic multi-turn sensor 110 and the angle sensor 108 provide a first level of resolution and precision. The signal output by the incremental sensor 124 from the second magnetic field 120 can then be used to provide a higher resolution measurement of the angular position for the rotatable shaft 104 which is provided by the multiple tracks 118 providing a high resolution of angular position.

The second magnetic sensing device 115, including the incremental sensor 124, along with the first magnetic sensing device 106, including the angle sensor 108 and the magnetic multi-turn sensor 110, can be mounted to substrates. The substrates can be printed circuit boards or other rigid structure for maintaining the position of the first magnetic sensing device 106 and the second magnetic sensing device 115 relative to the rotatable shaft 104, the magnet 102, and the magnetic target 116.

It is contemplated that the substrates could be separate substrates, illustratively a first substrate 126 can support and connect the angle sensor 108 and the magnetic multi-turn sensor 110, and a second substrate 128 can support and connect the incremental sensor 124. The substrates and could be coupled mechanically or through communication channels and support structures.

Around the magnet 102 a shield 132 is mounted and positioned. The shield 132 can prevent cross field interactions between the first magnetic field 112 and the second magnetic field 120.

Furthermore, the shield 132 can prevent the second magnetic field 120 from the magnetic target 112 from interfering, inducing noise, or false readings on the angle sensor 108 and the magnetic multi-turn sensor 110. Still further, the shield 132 can prevent the first magnetic field 112 from the magnet 102 from interfering, inducing noise, or false readings on the incremental sensor 124.

Referring now to FIG. 2, therein is shown an exploded isometric view of the measurement system 200 in a second embodiment. The measurement system 200 can be a magnetic sensor system, comprising a magnet 202 mounted on a rotatable shaft 204.

The measurement system 200 can further include a first magnetic sensing device 206 configured to be in a vicinity of the magnet 202, the first magnetic sensing device 206 can comprise an angle sensor 208 and a magnetic multi-turn sensor 210. The angle sensor 208 can be configured to detect an orientation of a first magnetic field 212 generated by the magnet 202 as the rotatable shaft 204 is rotated.

The magnetic multi-turn sensor 210 can be configured to detect a number of turns 214 of the first magnetic field 212 caused by the magnet 202 rotating on the rotatable shaft 204. Both the angle sensor 208 and the magnetic multi-turn sensor 210 are configured to read the first magnetic field 212.

With both the magnetic multi-turn sensor 210 and the angle sensor 208 within the first magnetic sensing device 206, a wide angle-range can be read and detected. For instance, the angle sensor 208 can determine angles between 0 and 360 degrees, while the multi-turn sensor could, for example, count to 48 turns and provide a range of 48 times 360 degrees or 17280 degrees of measurement.

To increase the resolution and precision of the measurements of the first magnetic sensing device 206, a second magnetic sensing device 215 can be included. The second magnetic sensing device 215 consists of a magnetic target 216 or disk such as a pole-ring, a soft magnetic gear, a soft magnetic disk with holes, or a pole disk.

The second magnetic sensing device 215 can detect the magnetic field change caused by the magnetic target 216 as it is rotated by the rotatable shaft 204. The magnetic target 216 can comprise at least one track 218 for inducing a change in a second magnetic field 220 generated by the magnetic target 216.

The tracks 218 can be magnetic areas formed as magnetic segments on a circumference 222 of the magnetic target 216. The second magnetic sensing device 215 can include incremental sensors 224 configured to detect changes in the second magnetic field 220 induced by the tracks 218 as the rotatable shaft 204 is rotated.

The incremental sensors 224 can be two off-shaft angle sensors offset by 180 degrees mechanically. It has been discovered that including multiple incremental sensors 224 increases redundancy, which allows the measurement system 200 to continue to accurately measure angle even if one of the incremental sensors 224 is offline. Furthermore, the multiple incremental sensors 224 can increase accuracy of the measurement.

Together, the first magnetic sensing device 206 and the second magnetic sensing device 215 provide a higher level of precision and resolution. That is, the magnetic multi-turn sensor 210 counts the number of turns 214 of the magnet 202 on the rotatable shaft 204 from the first magnetic field 212 while the angle sensor 208 measures the absolute angle of the rotatable shaft 204 from the first magnetic field 212.

The measurements made by the magnetic multi-turn sensor 210 and the angle sensor 208 provide a first level of resolution and precision. The signal output by the incremental sensors 224 from the second magnetic field 220 can then be used to provide a higher resolution measurement of the angular position for the rotatable shaft 204.

The second magnetic sensing device 215, including the incremental sensors 224, along with the first magnetic sensing device 206, including the angle sensor 208 and the magnetic multi-turn sensor 210, can be mounted to substrates. The substrates can be printed circuit boards or other rigid structure for maintaining the position of the first magnetic sensing device 206 and the second magnetic sensing device 215 relative to the rotatable shaft 204, the magnet 202, and the magnetic target 216.

The first magnetic sensing device 206 can consist of a first substrate 226 for supporting and connecting the angle sensor 208 and the magnetic multi-turn sensor 210. The second magnetic sensing device 215 can consist of a second substrate 228 for supporting and connecting the incremental sensors 224.

The first substrate 226 can consists of a first disk shaped printed circuit board while the second substrate 228 consists of a ring shaped printed circuit board. The first substrate 226 and the second substrate 228 are connected electrically with a bridge interconnect 230 extending therebetween.

The arrangement is provided as an illustrative example and methods for connecting substrates may be different from application to application. Also, an arrangement using printed circuit boards may not be needed. This arrangement could also be achieved using customized lead-frames, molded interconnect device, or other suitable technologies.

Around the magnet 202 a shield 232 is mounted and positioned. The shield 232 can prevent cross field interactions between the first magnetic field 212 and the second magnetic field 220.

Furthermore, the shield 232 can prevent the second magnetic field 220 from the magnetic target 212 from interfering, inducing noise, or false readings on the angle sensor 208 and the magnetic multi-turn sensor 210. Still further, the shield 232 can prevent the first magnetic field 212 from the magnet 202 from interfering, inducing noise, or false readings on the incremental sensors 224.

The first magnetic sensing device 206 and the second magnetic sensing device 215 can be coupled to a controller 234 for reading the angle sensor 208, the magnetic multi-turn sensor 210, and the incremental sensor 224. Each embodiment disclosed herein is contemplated to be coupled to a controller for reading sensors of the first magnetic sensing device and the second magnetic sensing device. The controller 234 can incorporate multiple input channels to directly or indirectly read signal information from the angle sensor 208, the magnetic multi-turn sensor 210, and the incremental sensor 224.

The controller 234 can read the magnetic multi-turn sensor 210 and determine a number of turns of the rotatable shaft 204 whether the rotatable shaft 204 was turned during a power off condition or a power on condition. Particularly, the magnetic multi-turn sensor 210 includes a multi-turn spiral and magnetization of the multi-turn spiral propagates domain walls within the multi-turn spiral when the rotatable shaft 204 is rotated.

Once the controller 234 is powered back on the domain walls positioned within the multi-turn spiral of the magnetic multi-turn sensor 210 can be read and the number of turns of the rotatable shaft 204 can be determined by the location of the domain walls within the magnetic multi-turn sensor 210. It has been discovered that electronic systems implementing the magnetic multi-turn sensor 210 can therefore recover without rehoming after a power down situation.

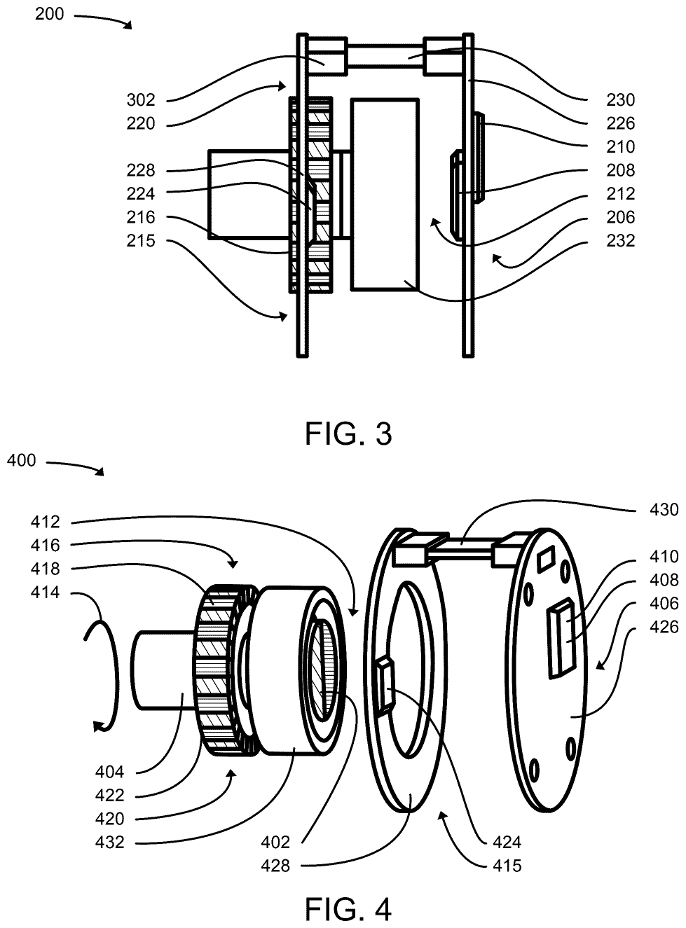

Referring now to FIG. 3, therein is shown a side view of the measurement system 200 in a second embodiment of FIG. 2. The measurement system 200 is shown with the first magnetic sensing device 206 and the second magnetic sensing device 215 within measuring distance of the first magnetic field 212 and the second magnetic field 220, respectively.

That is, the incremental sensors 224 on the second substrate 228 can read the second magnetic field 220 induced by the magnetic target 216. Furthermore, the magnetic multi-turn sensor 210 and the angle sensor 208 can read the first magnetic field 212 induced by the magnet 202 of FIG. 2.

The angle sensor 208 can be on a side of the first substrate 226 facing the magnet 202 while the magnetic multi-turn sensor 210 can be on a side of the first substrate 226 facing away from the magnet 202. However, it is contemplated that the positions of the magnetic multi-turn sensor 210 and the angle sensor 208 can be reversed.

The shield 232 is shown to extend fully around the magnet 202 and between the magnet 202 and the magnetic target 216. The shield 232 extending in this way can reduce or eliminate magnetic interference between the magnet 202 and the magnetic target 216.

The bridge interconnect 230 is shown extending between the first substrate 226 and the second substrate 228 and coupled to the substrates with coupling hardware 302, such as press fit or screwable coupling hardware, which can provide mechanical stability as well as solid communications connections between the substrates and the bridge interconnect 230.

Referring now to FIG. 4, therein is shown an exploded isometric view of the measurement system 400 in a third embodiment. The measurement system 400 can be a magnetic sensor system, comprising a magnet 402 mounted on a rotatable shaft 404.

The measurement system 400 can further include a first magnetic sensing device 406 configured to be in a vicinity of the magnet 402, the first magnetic sensing device 406 can comprise an angle sensor 408 and a magnetic multi-turn sensor 410. The angle sensor 408 can be configured to detect an orientation of a first magnetic field 412 generated by the magnet 402 as the rotatable shaft 404 is rotated.

The magnetic multi-turn sensor 410 can be configured to detect a number of turns 414 of the first magnetic field 412 caused by magnet 402 rotating on the rotatable shaft 404. Both the angle sensor 408 and the magnetic multi-turn sensor 410 are configured to read the first magnetic field 412.

To increase the resolution and precision of the measurements of the first magnetic sensing device 406, a second magnetic sensing device 415 can be included. The second magnetic sensing device 415 consists of a magnetic target 416 or disk such as a pole-ring, a soft magnetic gear, a soft magnetic disk with holes, or a pole disk.

The second magnetic sensing device 415 can detect the magnetic field change caused by the magnetic target 416 as it is rotated by the rotatable shaft 404. The magnetic target 416 can comprise at least one track 418 for inducing a change in a second magnetic field 420 generated by the magnetic target 416.

The tracks 418 can be magnetic areas formed as magnetic segments on a circumference 422 of the magnetic target 416. The second magnetic sensing device 415 can include an incremental sensor 424 configured to detect changes in the second magnetic field 420 induced by the tracks 418 as the rotatable shaft 404 is rotated. The incremental sensor 424 can be a fixed pitch position sensor.

Together, the first magnetic sensing device 406 and the second magnetic sensing device 415 provide a higher level of precision and resolution. That is, the magnetic multi-turn sensor 410 counts the number of turns 414 of the magnet 402 on the rotatable shaft 404 from the first magnetic field 412 while the angle sensor 408 measures the absolute angle of the rotatable shaft 404 from the first magnetic field 412.

The measurements made by the magnetic multi-turn sensor 410 and the angle sensor 408 provide a first level of resolution and precision. The signal output by the incremental sensor 424 from the second magnetic field 420 can then be used to provide a higher resolution measurement of the angular position for the rotatable shaft 404.

The second magnetic sensing device 415, including the incremental sensor 424, along with the first magnetic sensing device 406, including the angle sensor 408 and the magnetic multi-turn sensor 410, can be mounted to substrates. The substrates can be printed circuit boards or other rigid structure for maintaining the position of the first magnetic sensing device 406 and the second magnetic sensing device 415 relative to the rotatable shaft 404, the magnet 402, and the magnetic target 416.

The first magnetic sensing device 406 can consist of a first substrate 426 for supporting and connecting the angle sensor 408 and the magnetic multi-turn sensor 410. The second magnetic sensing device 415 can consist of a second substrate 428 for supporting and connecting the incremental sensors 424.

The first substrate 426 can consists of a first disk shaped printed circuit board while the second substrate 428 consists of a ring shaped printed circuit board. The first substrate 426 and the second substrate 428 are connected electrically with a bridge interconnect 430 extending therebetween.

Around the magnet 402 a shield 432 is mounted and positioned. The shield 432 can prevent cross field interactions between the first magnetic field 412 and the second magnetic field 420.

Referring now to FIGS. 5-11, these FIGS. depict various end shaft magnets, which can be used in any embodiment disclosed herein as the magnet at the end of the rotatable shaft. Illustratively for example, any of the end of shaft magnets from FIGS. 5-11 could be the magnet 102 of FIG. 1.

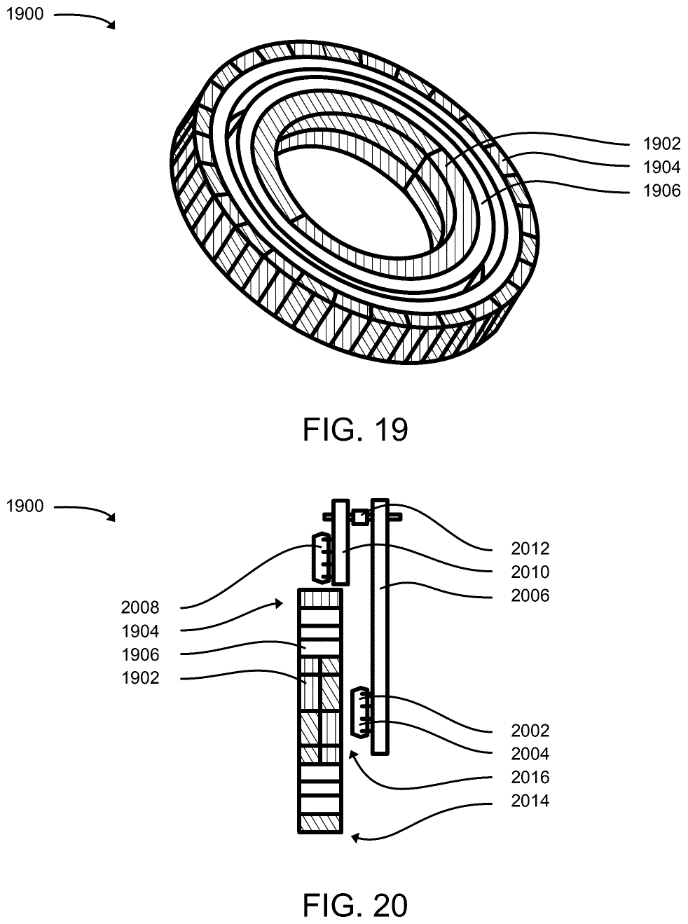

The end shaft magnets of FIGS. 5-11 disclose various shapes and magnetizations of the end shaft magnets. It is contemplated also that the magnet could be split into two or more segments as well. As, for example, is shown in FIG. 19.

Referring now to FIG. 5, therein is shown a side view of an end shaft magnet 502 for any embodiment of the measurement system. The end shaft magnet 502 is shown with a rectangular shape.

Referring now to FIG. 6, therein is shown a side view of an end shaft magnet 602 for any embodiment of the measurement system. The end shaft magnet 602 is shown with a round or circular shape.

Referring now to FIG. 7, therein is shown a side view of an end shaft magnet 702 for any embodiment of the measurement system. The end shaft magnet 702 is shown with a ring shape.

Referring now to FIG. 8, therein is shown a side view of an end shaft magnet 802 for any embodiment of the measurement system. The end shaft magnet 802 is shown with a hexagonal shape.

Referring now to FIG. 9, therein is shown an isometric view of an end shaft magnet 902 for any embodiment of the measurement system. The end shaft magnet 902 is shown with a diametral magnetization.

Referring now to FIG. 10, therein is shown an isometric view of an end shaft magnet 1002 for any embodiment of the measurement system. The end shaft magnet 1002 is shown with a split axial magnetization.

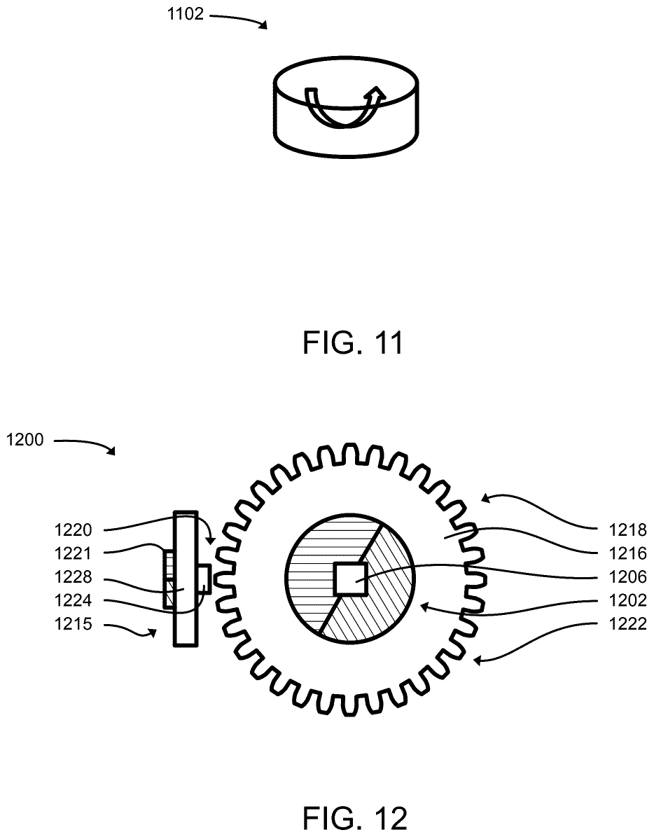

Referring now to FIG. 11, therein is shown an isometric view of an end shaft magnet 1102 for any embodiment of the measurement system. The end shaft magnet 1102 is shown with a bowed magnetization.

Referring now to FIG. 12, therein is shown a side view of the measurement system 1200 in a fourth embodiment. The measurement system 1200 can be a magnetic sensor system, comprising a magnet 1202, such as a two-pole magnet, mounted on a rotatable shaft (not shown) configured to be in a vicinity a first magnetic sensing device 1206 that can comprise an angle sensor and a magnetic multi-turn sensor.

To increase the resolution and precision of the measurements of the first magnetic sensing device 1206, a second magnetic sensing device 1215 can be included. The second magnetic sensing device 1215 consists of a magnetic target 1216 coupled to the rotatable shaft. It is contemplated that the magnetic target 1216 of the present embodiment could be used with any embodiment disclosed herein.

The magnet 1202 is shown at the center of the magnetic target 1216. The magnetic target 1216 can comprise at least one track 1218 for inducing a change in a second magnetic field 1220 generated by a back-biasing magnet 1221. The tracks 1218 can be teeth of a soft magnetic gear, which generate magnetic repetitions as the magnetic target 1216 is rotated through the second magnetic field 1220 of the back-biasing magnet 1221. It is contemplated that the number of the teeth can be tailored to the specific application with more teeth providing a finer resolution.

The tracks 1218 can be formed on a circumference 1222 of the magnetic target 1216. The second magnetic sensing device 1215 can include an incremental sensor 1224 configured to detect changes in the second magnetic field 1220 induced by the tracks 1218 as they are rotated through the second magnetic field 1220 of the back-biasing magnet 1221.

The incremental sensor 1224 and the back-biasing magnet 1221 can be on either side of a second substrate 1228 of the second magnetic sensing device 1215. The back-biasing magnet 1221 can be behind the incremental sensor 1224 when the incremental sensor 1224 faces the magnetic target 1216.

More particularly, the incremental sensor 1224 is between the magnetic target 1216 and the back-biasing magnet 1221. The incremental sensor 1224 can be a fixed pitch position sensor and can be located, together with the second substrate 1228 and the back-biasing magnet 1221, beyond the circumference 1222 of the magnetic target 1216 relative to the rotatable shaft.

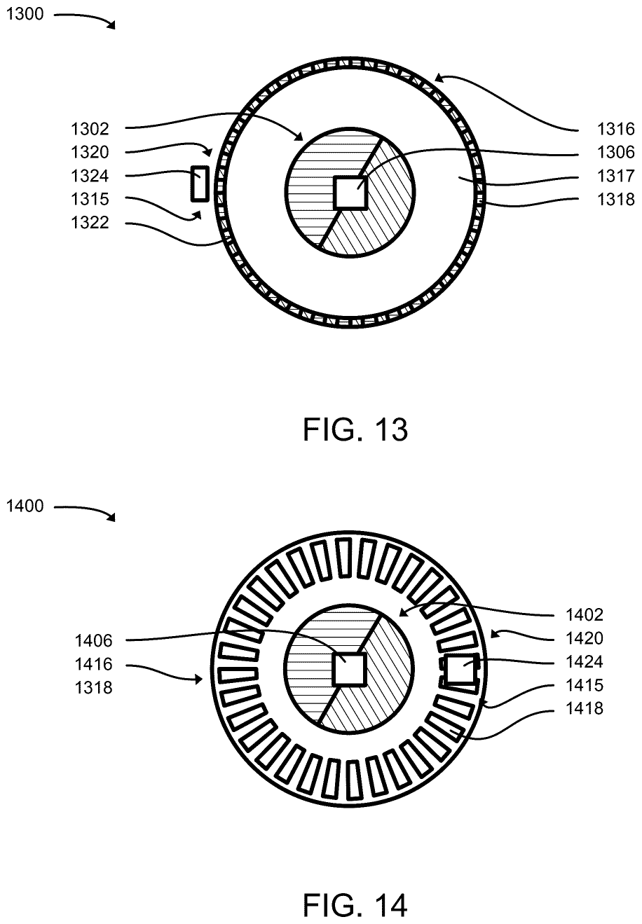

Referring now to FIG. 13, therein is shown a side view of the measurement system 1300 in a fifth embodiment. The measurement system 1300 can be a magnetic sensor system, comprising a magnet 1302 mounted on a rotatable shaft (not shown) configured to be in a vicinity a first magnetic sensing device 1306 that can comprise an angle sensor and a magnetic multi-turn sensor.

To increase the resolution and precision of the measurements of the first magnetic sensing device 1306, a second magnetic sensing device 1315 can be included. The second magnetic sensing device 1315 consists of a magnetic target 1316 coupled to the rotatable shaft. It is contemplated that the magnetic target 1316 of the present embodiment could be used with any embodiment disclosed herein. Between the magnet 1302 and the magnetic target 1316 is a shield 1317 that can touch both the magnet 1302 and the magnetic target 1317. There is no need for an air gap between shield 1307 and magnetic target 1316 or between the shield 1307 and the magnet 1302.

The magnetic target 1316 can comprise at least one track 1318 for inducing a change in a second magnetic field 1320 generated by the magnetic target 1316 itself. The tracks 1318 can be magnetic areas formed from a plurality of curved magnetic segments distributed around a circumference 1322 of the magnetic target 1316. It is contemplated that the number of the curved segments can be tailored to the specific application with more segments providing a finer resolution.

The tracks 1318 can be formed on or as the circumference 1322 of the magnetic target 1316. The second magnetic sensing device 1315 can include an incremental sensor 1324 configured to detect changes in the second magnetic field 1320 induced by the tracks 1318 as they rotate past. The incremental sensor 1324 can be a fixed pitch position sensor and can be located beyond the circumference 1322 of the magnetic target 1316 relative to the rotatable shaft.

Referring now to FIG. 14, therein is shown a side view of the measurement system 1400 in a sixth embodiment. The measurement system 1400 can be a magnetic sensor system, comprising a magnet 1402 mounted on a rotatable shaft (not shown) configured to be in a vicinity a first magnetic sensing device 1406 that can comprise an angle sensor and a magnetic multi-turn sensor.

To increase the resolution and precision of the measurements of the first magnetic sensing device 1406, a second magnetic sensing device 1415 can be included. The second magnetic sensing device 1415 consists of a magnetic target 1416 coupled to the rotatable shaft. It is contemplated that the magnetic target 1416 of the present embodiment could be used with any embodiment disclosed herein.

The magnetic target 1416 can comprise at least one track 1418 for inducing a change in a second magnetic field 1420 generated by a back-biasing magnet (not shown). The tracks 1418 can be holes along a circumference 1422 of a soft magnetic disk.

The tracks 1418 generate magnetic repetitions as the magnetic target 1416 is rotated through the second magnetic field 1420 of the back-biasing magnet. It is contemplated that the number of the holes can be tailored to the specific application with more holes providing a finer resolution and more accuracy.

The second magnetic sensing device 1415 can include an incremental sensor 1424 configured to detect changes in the second magnetic field 1420 induced by the tracks 1418 as they are rotated through the second magnetic field 1420 of the back-biasing magnet.

The incremental sensor 1424 and the back-biasing magnet can be on either side of a second substrate (not shown) of the second magnetic sensing device 1415. The back-biasing magnet can be behind the incremental sensor 1424 when the incremental sensor 1424 faces the magnetic target 1416.

More particularly, the incremental sensor 1424 is between the magnetic target 1416 and the back-biasing magnet. The incremental sensor 1424 can be a fixed pitch position sensor and can be located, together with the second substrate and the back-biasing magnet, within the circumference 1422 of the magnetic target 1416 relative to the rotatable shaft.

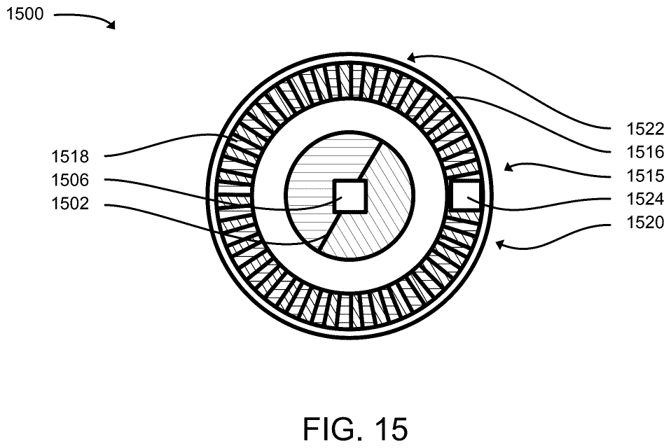

Referring now to FIG. 15, therein is shown a side view of the measurement system 1500 in a seventh embodiment. The measurement system 1500 can be a magnetic sensor system, comprising a magnet 1502 mounted on a rotatable shaft (not shown) configured to be in a vicinity a first magnetic sensing device 1506 that can comprise an angle sensor and a magnetic multi-turn sensor.

To increase the resolution and precision of the measurements of the first magnetic sensing device 1506, a second magnetic sensing device 1515 can be included. The second magnetic sensing device 1515 consists of a magnetic target 1516 coupled to the rotatable shaft. It is contemplated that the magnetic target 1516 of the present embodiment could be used with any embodiment disclosed herein.

The magnetic target 1516 can comprise at least one track 1518 for inducing a change in a second magnetic field 1520 generated by the magnetic target 1516 itself. The tracks 1518 can be magnetic areas formed from a plurality of curved magnetic segments distributed around a circumference 1522 of the magnetic target 1516. It is contemplated that the number of the curved segments can be tailored to the specific application with more segments providing a finer resolution.

The tracks 1518 can be formed just within the circumference 1522 of the magnetic target 1516 as a pole disk. The second magnetic sensing device 1515 can include an incremental sensor 1524 configured to detect changes in the second magnetic field 1520 induced by the tracks 1518 as they rotate past. The incremental sensor 1524 can be a fixed pitch position sensor and can be located within the circumference 1522 of the magnetic target 1516 relative to the rotatable shaft.

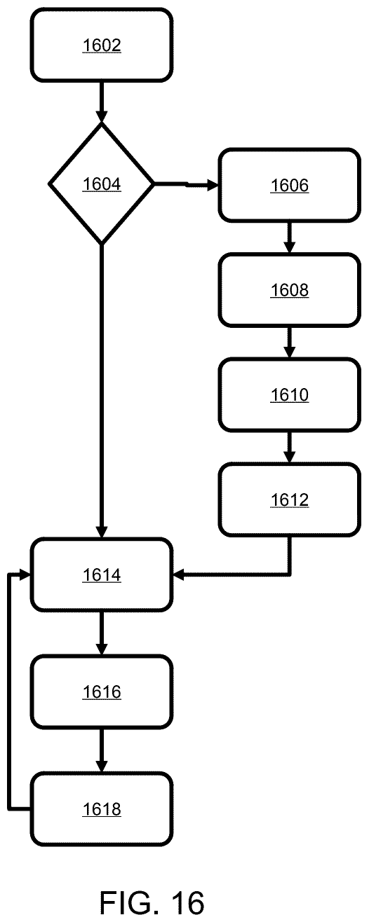

Referring now to FIG. 16, therein is shown a flow chart for operating the measurement system. The operation can begin with a power on step 1602 and proceed to an initial calibration decision step 1604. If the measurement system does not have a relationship defined for the angle sensor, the magnetic multi-turn sensor, and the incremental sensor, the initial calibration decision step 1604 will return a positive result and execute an initialization step 1606.

During initialization, which can be during manufacture or installation, a controller coupled to the angle sensor, the magnetic multi-turn sensor, and the incremental sensor executes an alignment routine and performs a series of measurements. The measurement system 100 can read the angle sensor and the magnetic multi-turn sensor at multiple points in a read first magnetic sensing device step 1608.

The measurement system can read the incremental sensor at the same points as measured in the read first magnetic sensing device step 1608. The incremental sensor can be read in a read second magnetic sensing device step 1610.

A relationship between the angle sensor, the magnetic multi-turn sensor, and the incremental sensor is established in a sensor relationship step 1612. Once the relationship is defined the measurement system can execute a coarse measurement step 1614.

Furthermore, if in the initial calibration decision step 1604, the measurement system does have a relationship defined for the angle sensor, the magnetic multi-turn sensor, and the incremental sensor, the initial calibration decision step 1604 will return a negative result and execute the coarse measurement step 1614. After initialization and during the coarse measurement step 1614, the controller can read a ‘coarse’ angular position from the angle sensor and the magnetic multi-turn sensor which allows it to identify the absolute position of the incremental encoder within coarse bounds.

Once the coarse measurement step 1614 is completed, the measurement system can execute a high precision measurement step 1616. During the high precision measurement step 1616, the controller can then take the output of the incremental sensor and interpolate the exact position of the shaft to a high precision.

Once the high precision measurement step 1616 is completed the controller can combine the outputs from the angle sensor and the magnetic multi-turn sensor together with the output from the incremental sensor to generate a representation of shaft position which combines precise angle information together with turn-count information in an output step 1618.

The controller therefore reads turn-count information from the angle sensor and the magnetic multi-turn sensor which allows it to determine shaft rotation to high precision within multiple 360° rotations. It has been discovered that once the relationship between the angle sensor, the magnetic multi-turn sensor, and the incremental sensor is established in the sensor relationship step 1612, the measurement system does not need to be reinitialized.

This is because the magnetic multi-turn sensor can detect the position of the rotatable shaft even during power off conditions. When power is restored, the controller can read the magnetic multi-turn sensor and establish movement during the power off condition and determine the coarse measurement for example in the coarse measurement step 1614.

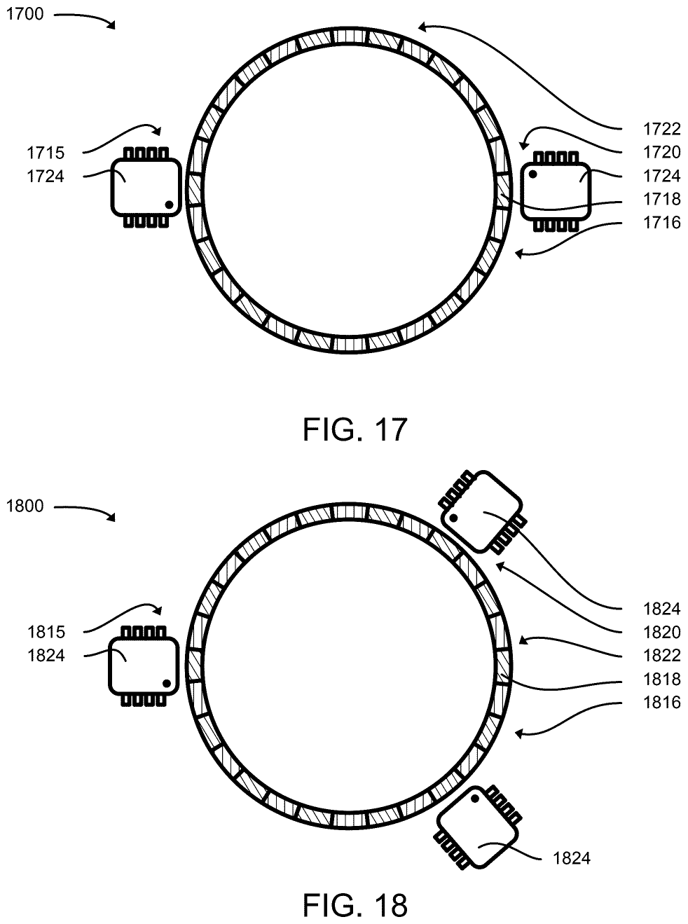

Referring now to FIG. 17, therein is shown a side view of the measurement system 1700 in an eighth embodiment. The measurement system 1700 is depicted with a second magnetic sensing device 1715 consisting of a magnetic target 1716 coupled to a rotatable shaft (not shown).

The magnetic target 1716 can comprise at least one track 1718 for inducing a change in a second magnetic field 1720 generated by the magnetic target 1716 itself. The tracks 1718 can be magnetic areas formed from a plurality of curved magnetic segments distributed to create a circumference 1722 of the magnetic target 1716.

Under normal circumstances it cannot be avoided that the magnetic target 1716 becomes mechanically eccentric after mounting it on the shaft. This is termed runout. Due to runout, it is advantageous to have multiple incremental sensors 1724 detecting the field changes on the magnetic target 1716, which eliminates the runout impact of the magnetic target 1716.

The multiple incremental sensors 1724 can be located beyond the circumference 1722 of the magnetic target 1716 relative to the rotatable shaft. Usually, these incremental sensors 1724 are distributed in equal angular distances such as 180 degrees, as is shown. However, it is contemplated that the incremental sensors 1724 can be spaced in un-equal angular distances which requires more complicated calculations to eliminate the runout.

Referring now to FIG. 18, therein is shown a side view of the measurement system 1800 in a ninth embodiment. The measurement system 1800 is depicted with a second magnetic sensing device 1815 consisting of a magnetic target 1816 coupled to a rotatable shaft (not shown).

The magnetic target 1816 can comprise at least one track 1818 for inducing a change in a second magnetic field 1820 generated by the magnetic target 1816 itself. The tracks 1818 can be magnetic areas formed from a plurality of curved magnetic segments distributed at a circumference 1822 of the magnetic target 1816.

Under normal circumstances it cannot be avoided that the magnetic target 1816 becomes mechanically eccentric after mounting it on the shaft. This is termed runout. Due to runout, it is advantageous to have multiple incremental sensors 1824 detecting the field changes on the magnetic target 1816, which eliminates the runout impact of the magnetic target 1816.

The multiple incremental sensors 1824 can be located beyond the circumference 1822 of the magnetic target 1816 relative to the rotatable shaft. Usually, these incremental sensors 1824 are distributed in equal angular distances such as 120 degrees, as is shown. However, it is contemplated that the incremental sensors 1824 can be spaced in un-equal angular distances which requires more complicated calculations to eliminate the runout.

Referring now to FIG. 19, therein is shown an isometric view of the measurement system 1900 in a tenth embodiment. The measurement system 1900 provides a compact arrangement placing a magnet 1902 coupled to a rotatable shaft (not shown) and inside a magnetic target 1904.

The magnet 1902 can be a split axial magnet while the magnetic target 1904 can be a pole-ring. Between the magnet 1902 and the magnetic target 1904, a shield 1906 can be located. The shield 1906 can prevent magnetic field interactions between the magnet 1902 and the magnetic target 1904.

Referring now to FIG. 20, therein is shown a cross-sectional view of the measurement system 1900 in the tenth embodiment of FIG. 19. The magnet 1902 is shown within the magnetic target 1904 with the shield 1906 therebetween.

The measurement system 1900 is shown having an angle sensor 2002 and magnetic multi-turn sensor 2004 mounted to a first substrate 2006 and an incremental sensor 2008 mounted to a second substrate 2010. The first substrate 2006 can be coupled to the second substrate 2010 with a bridge interconnect 2012 therebetween.

The bridge interconnect 2012 can be a conductive wire or plurality of wires. Furthermore, the bridge interconnect 2012 can include a stabilizing insulator, which can add to mechanical stability. The incremental sensor 2008 is located beyond a circumference 2014 of the magnetic target 1904 relative to the rotatable shaft.

It has been discovered that the magnet 1902 has a first magnetic field 2016 predominantly in an axial direction, relative to the rotatable shaft (not shown). The position of the incremental sensor 2008 avoids this first magnetic field 2016 by the shield 1906 and avoids cross field interactions.

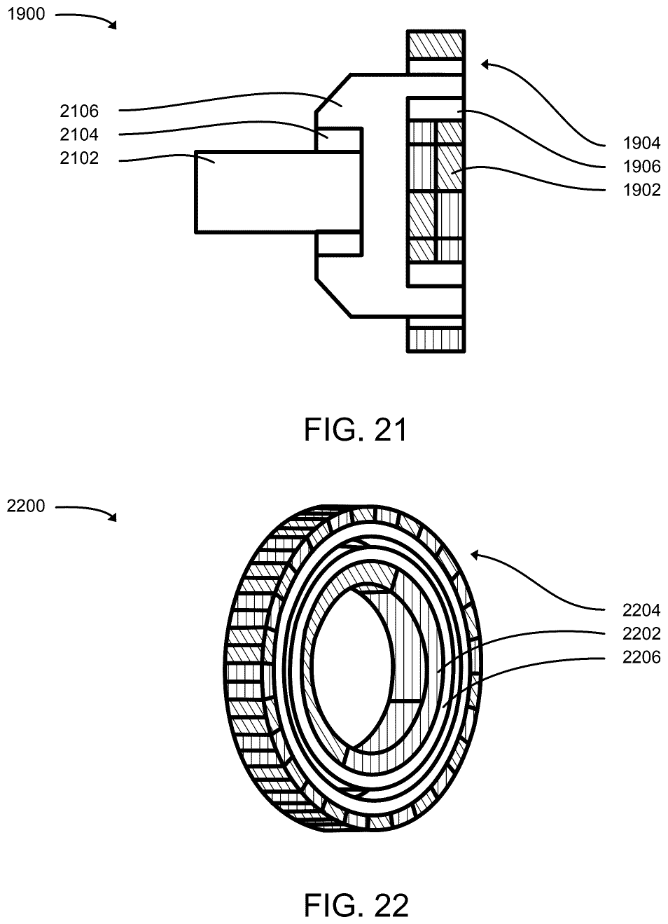

Referring now to FIG. 21, therein is shown a cross-sectional view of the measurement system 1900 in the tenth embodiment of FIG. of FIG. 19 after an over molding phase of manufacture. The measurement system 1900 is depicted adapted to a rotatable shaft 2102.

The magnet 1902, the shield 1906, and the magnetic target 1904 is shown adapted to the rotatable shaft 2102. The magnet 1902, the shield 1906, and the magnetic target 1904 together with a press fit bushing 2104 are over molded with a mold compound 2106.

The rotatable shaft 2102 can be press fit into the press fit bushing 2104 and thereby mechanically coupled to the magnet 1902 and the magnetic target 1904. It has been discovered that the mold compound 2106 together with the compact design of the magnet 1902, the shield 1906, and the magnetic target 1904 provide advantages of a smaller footprint and more mechanical rigidity.

Referring now to FIG. 22, therein is shown an isometric view of the measurement system 2200 in an eleventh embodiment. The measurement system 2200 provides a compact arrangement placing a magnet 2202 coupled to a rotatable shaft (not shown) and inside a magnetic target 2204.

The magnet 2202 can be a diametral magnet while the magnetic target 2204 can be a pole-ring. Between the magnet 2202 and the magnetic target 2204, a shield 2206 can be located. The shield 2206 can prevent magnetic field interactions between the magnet 2202 and the magnetic target 2204.

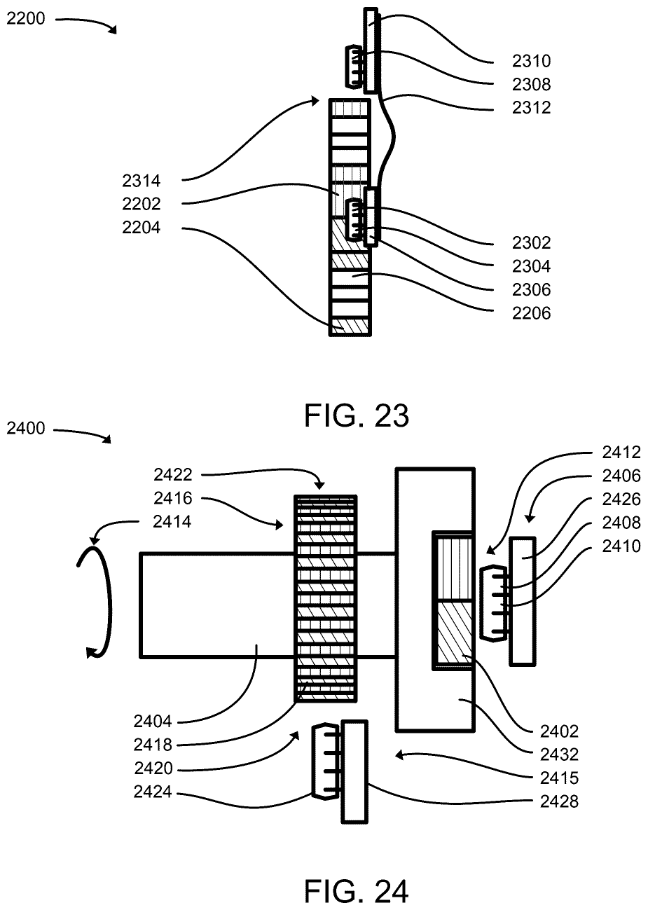

Referring now to FIG. 23, therein is shown a cross-sectional view of the measurement system 2200 in the eleventh embodiment of FIG. 22. The magnet 2202 is shown within the magnetic target 2204 with the shield 2206 therebetween.

The measurement system 2200 is shown having an angle sensor 2302 and magnetic multi-turn sensor 2304 mounted to a first substrate 2306 and an incremental sensor 2308 mounted to a second substrate 2310. The first substrate 2306 can be coupled to the second substrate 2310 with a bridge interconnect 2312 therebetween.

The arrangement is a compact magnet arrangement with the magnet 2202 having a diametral magnetization in this instance. This requires placing the angle sensor 2302 and the magnetic multi-turn sensor 2304 to be mounted inside the magnet 2202 as depicted. The first substrate 2306 and the second substrate 2310 can be co-planar.

The bridge interconnect 2312 can be a flexible printed circuit board. The incremental sensor 2308 is located beyond a circumference 2314 of the magnetic target 2204 relative to the rotatable shaft.

Referring now to FIG. 24, therein is shown a side view of the measurement system 2400 in a twelfth embodiment. The measurement system 2400 can be a magnetic sensor system, comprising a magnet 2402 mounted on a rotatable shaft 2404.

The measurement system 2400 can further include a first magnetic sensing device 2406 configured to be in a vicinity of the magnet 2402, the first magnetic sensing device 2406 can comprise an angle sensor 2408 and a magnetic multi-turn sensor 2410. The angle sensor 2408 can be configured to detect an orientation of a first magnetic field 2412 generated by the magnet 2402 as the rotatable shaft 2404 is rotated.

The magnetic multi-turn sensor 2410 can be configured to detect a number of turns 2414 of the first magnetic field 2412 caused by the magnet 2402 rotating on the rotatable shaft 2404. Both the angle sensor 2408 and the magnetic multi-turn sensor 2410 are configured to read the first magnetic field 2412.

With both the magnetic multi-turn sensor 2410 and the angle sensor 2408 within the first magnetic sensing device 2406, a wide angle-range can be read and detected. For instance, the angle sensor 2408 can determine angles between 0 and 360 degrees, while the multi-turn sensor could, for example, count to 48 turns and provide a range of 48 times 360 degrees or 17280 degrees of measurement.

To increase the resolution and precision of the measurements of the first magnetic sensing device 2406, a second magnetic sensing device 2415 can be included. The second magnetic sensing device 2415 consists of a magnetic target 2416 or disk depicted as a pole-ring or a pole disk.

The second magnetic sensing device 2415 can detect the magnetic field change caused by the magnetic target 2416 as it is rotated by the rotatable shaft 2404. The magnetic target 2416 can comprise at least one track 2418 for inducing a change in a second magnetic field 2420 generated by the magnetic target 2416.

The tracks 2418 can be formed on a circumference 2422 of the magnetic target 2416. The second magnetic sensing device 2415 can include an incremental sensor 2424 configured to detect changes in the second magnetic field 2420 induced by the tracks 2418 as the rotatable shaft 2404 is rotated.

Together, the first magnetic sensing device 2406 and the second magnetic sensing device 2415 provide a higher level of precision and resolution. That is, the magnetic multi-turn sensor 2410 counts the number of turns 2414 of the magnet 2402 on the rotatable shaft 2404 from the first magnetic field 2412 while the angle sensor 2408 measures the absolute angle of the rotatable shaft 2404 from the first magnetic field 2412.

The measurements made by the magnetic multi-turn sensor 2410 and the angle sensor 2408 provide a first level of resolution and precision. The signal output by the incremental sensor 2424 from the second magnetic field 2420 can then be used to provide a higher resolution measurement of the angular position for the rotatable shaft 2404.

The second magnetic sensing device 2415, including the incremental sensor 2424, along with the first magnetic sensing device 2406, including the angle sensor 2408 and the magnetic multi-turn sensor 2410, can be mounted to substrates. The substrates can be printed circuit boards or other rigid structure for maintaining the position of the first magnetic sensing device 2406 and the second magnetic sensing device 2415 relative to the rotatable shaft 2404, the magnet 2402, and the magnetic target 2416.

The first magnetic sensing device 2406 can consist of a first substrate 2426 for supporting and connecting the angle sensor 2408 and the magnetic multi-turn sensor 2410. The second magnetic sensing device 2415 can consist of a second substrate 2428 for supporting and connecting the incremental sensor 2424.

The first substrate 2426 and the second substrate 2428 are connected electrically with a bridge interconnect (not shown) extending therebetween. An arrangement using printed circuit boards may not be needed. This arrangement could also be achieved using customized lead-frames, molded interconnect device, or other suitable technologies.

Around the magnet 2402 a shield 2432 is mounted and positioned. The shield 2432 can prevent cross field interactions between the first magnetic field 2412 and the second magnetic field 2420.

Furthermore, the shield 2432 can prevent the second magnetic field 2420 from the magnetic target 2412 from interfering, inducing noise, or false readings on the angle sensor 2408 and the magnetic multi-turn sensor 2410. Still further, the shield 2432 can prevent the first magnetic field 2412 from the magnet 2402 from interfering, inducing noise, or false readings on the incremental sensor 2424.

The first magnetic sensing device 2406 and the second magnetic sensing device 2415 can be coupled to a controller (not shown) for reading the angle sensor 2408, the magnetic multi-turn sensor 2410, and the incremental sensor 2424.

The incremental sensor 2424 can be a fixed pitch position sensor and can be located, together with the second substrate 2428, beyond the circumference 2422 of the magnetic target 2416 relative to the rotatable shaft 2404. The incremental sensor 2424 can measure in an off-axial direction of the rotatable shaft 2404, which should be understood as not in line with the rotatable shaft 2404, and as shown, substantially perpendicular.

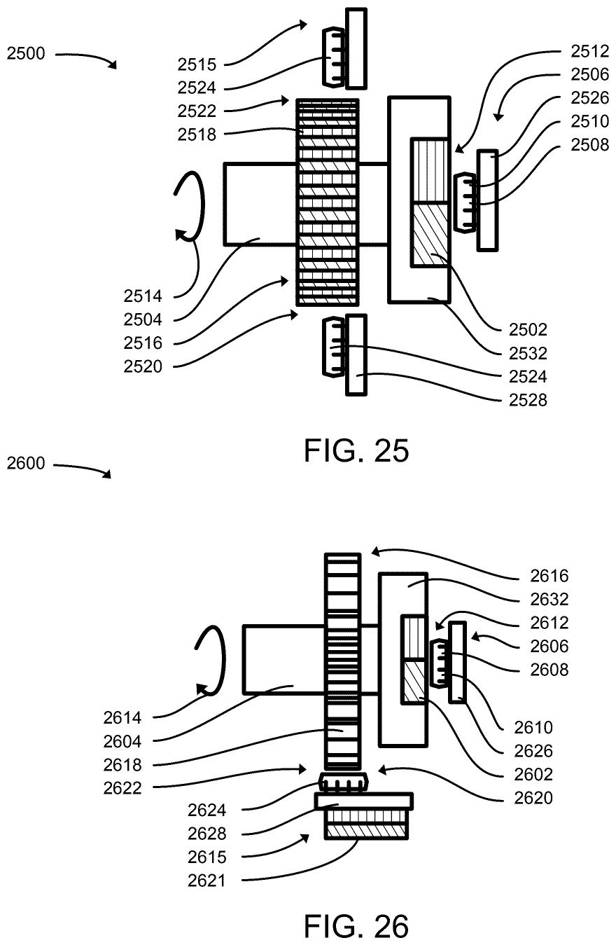

Referring now to FIG. 25, therein is shown a side view of the measurement system 2500 in a thirteenth embodiment. The measurement system 2500 can be a magnetic sensor system, comprising a magnet 2502 mounted on a rotatable shaft 2504.

The measurement system 2500 can further include a first magnetic sensing device 2506 configured to be in a vicinity of the magnet 2502, the first magnetic sensing device 2506 can comprise an angle sensor 2508 and a magnetic multi-turn sensor 2510. The angle sensor 2508 can be configured to detect an orientation of a first magnetic field 2512 generated by the magnet 2502 as the rotatable shaft 2504 is rotated.

The magnetic multi-turn sensor 2510 can be configured to detect a number of turns 2514 of the first magnetic field 2512 caused by the magnet 2502 rotating on the rotatable shaft 2504. Both the angle sensor 2508 and the magnetic multi-turn sensor 2510 are configured to read the first magnetic field 2512.

With both the magnetic multi-turn sensor 2510 and the angle sensor 2508 within the first magnetic sensing device 2506, a wide angle-range can be read and detected. For instance, the angle sensor 2508 can determine angles between 0 and 360 degrees, while the multi-turn sensor could, for example, count to 48 turns and provide a range of 48 times 360 degrees or 17280 degrees of measurement.

To increase the resolution and precision of the measurements of the first magnetic sensing device 2506, a second magnetic sensing device 2515 can be included. The second magnetic sensing device 2515 consists of a magnetic target 2516 or disk depicted as a pole-ring or a pole disk.

The second magnetic sensing device 2515 can detect the magnetic field change caused by the magnetic target 2516 as it is rotated by the rotatable shaft 2504. The magnetic target 2516 can comprise at least one track 2518 for inducing a change in a second magnetic field 2520 generated by the magnetic target 2516.

The tracks 2518 can be formed on a circumference 2522 of the magnetic target 2516. The second magnetic sensing device 2515 can include incremental sensors 2524 configured to detect changes in the second magnetic field 2520 induced by the tracks 2518 as the rotatable shaft 2504 is rotated.

The incremental sensors 2524 can be two off-shaft angle sensors offset by 180 degrees mechanically. It has been discovered that including multiple incremental sensors 2524 increases redundancy, which allows the measurement system 2500 to continue to accurately measure angle even if one of the incremental sensors 2524 is offline. Furthermore, the multiple incremental sensors 2524 can increase accuracy of the measurement.

Together, the first magnetic sensing device 2506 and the second magnetic sensing device 2515 provide a higher level of precision and resolution. That is, the magnetic multi-turn sensor 2510 counts the number of turns 2514 of the magnet 2502 on the rotatable shaft 2504 from the first magnetic field 2512 while the angle sensor 2508 measures the absolute angle of the rotatable shaft 2504 from the first magnetic field 2512.

The measurements made by the magnetic multi-turn sensor 2510 and the angle sensor 2508 provide a first level of resolution and precision. The signal output by the incremental sensors 2524 from the second magnetic field 2520 can then be used to provide a higher resolution measurement of the angular position for the rotatable shaft 2504.

The second magnetic sensing device 2515, including the incremental sensors 2524, along with the first magnetic sensing device 2506, including the angle sensor 2508 and the magnetic multi-turn sensor 2510, can be mounted to substrates. The substrates can be printed circuit boards or other rigid structure for maintaining the position of the first magnetic sensing device 2506 and the second magnetic sensing device 2515 relative to the rotatable shaft 2504, the magnet 2502, and the magnetic target 2516.

The first magnetic sensing device 2506 can consist of a first substrate 2526 for supporting and connecting the angle sensor 2508 and the magnetic multi-turn sensor 2510. The second magnetic sensing device 2515 can consist of a second substrate 2528 for supporting and connecting the incremental sensors 2524.

The first substrate 2526 and the second substrate 2528 are connected electrically with a bridge interconnect (not shown) extending therebetween. An arrangement using printed circuit boards may not be needed. This arrangement could also be achieved using customized lead-frames, molded interconnect device, or other suitable technologies.

Around the magnet 2502 a shield 2532 is mounted and positioned. The shield 2532 can prevent cross field interactions between the first magnetic field 2512 and the second magnetic field 2520.

Furthermore, the shield 2532 can prevent the second magnetic field 2520 from the magnetic target 2512 from interfering, inducing noise, or false readings on the angle sensor 2508 and the magnetic multi-turn sensor 2510. Still further, the shield 2532 can prevent the first magnetic field 2512 from the magnet 2502 from interfering, inducing noise, or false readings on the incremental sensors 2524.

The first magnetic sensing device 2506 and the second magnetic sensing device 2515 can be coupled to a controller (not shown) for reading the angle sensor 2508, the magnetic multi-turn sensor 2510, and the incremental sensor 2524. The incremental sensors 2524 can be located, together with the second substrate 2528, beyond the circumference 2522 of the magnetic target 2516 relative to the rotatable shaft 2504. The incremental sensor 2524 can measure in an off-axial direction of the rotatable shaft 2504, which should be understood as not in line with the rotatable shaft 3504, and as shown, substantially perpendicular.

Referring now to FIG. 26, therein is shown a side view of the measurement system 2600 in a fourteenth embodiment. The measurement system 2600 can be a magnetic sensor system, comprising a magnet 2602 mounted on a rotatable shaft 2604.

The measurement system 2600 can further include a first magnetic sensing device 2606 configured to be in a vicinity of the magnet 2602, the first magnetic sensing device 2606 can comprise an angle sensor 2608 and a magnetic multi-turn sensor 2610. The angle sensor 2608 can be configured to detect an orientation of a first magnetic field 2612 generated by the magnet 2602 as the rotatable shaft 2604 is rotated.

The magnetic multi-turn sensor 2610 can be configured to detect a number of turns 2614 of the first magnetic field 2612 caused by the magnet 2602 rotating on the rotatable shaft 2604. Both the angle sensor 2608 and the magnetic multi-turn sensor 2610 are configured to read the first magnetic field 2612.

With both the magnetic multi-turn sensor 2610 and the angle sensor 2608 within the first magnetic sensing device 2606, a wide angle-range can be read and detected. For instance, the angle sensor 2608 can determine angles between 0 and 360 degrees, while the multi-turn sensor could, for example, count to 48 turns and provide a range of 48 times 360 degrees or 17280 degrees of measurement.

To increase the resolution and precision of the measurements of the first magnetic sensing device 2606, a second magnetic sensing device 2615 can be included. The second magnetic sensing device 2615 consists of a magnetic target 2616 or disk depicted as a soft magnetic gear.

The magnetic target 2616 can comprise at least one track 2618 for inducing a change in a second magnetic field 2620 generated by a back-biasing magnet 2621. The tracks 2618 can be teeth of a soft magnetic gear, which generate magnetic repetitions as the magnetic target 2616 is rotated through the second magnetic field 2620 of the back-biasing magnet 2621. It is contemplated that the number of the teeth can be tailored to the specific application with more teeth providing a finer resolution.

The tracks 2618 can be formed on a circumference 2622 of the magnetic target 2616. The second magnetic sensing device 2615 can include an incremental sensor 2624 configured to detect changes in the second magnetic field 2620 induced by the tracks 2618 as they are rotated through the second magnetic field 2620 of the back-biasing magnet 2621.

While the first magnetic sensing device 2606 can consist of a first substrate 2626 supporting and connecting the angle sensor 2608 and the magnetic multi-turn sensor 2610, the second magnetic sensing device 2615 can consist of a second substrate 2628 for supporting and connecting the incremental sensor 2624.

The incremental sensor 2624 and the back-biasing magnet 2621 can be on either side of the second substrate 2628. The back-biasing magnet 2621 can be behind the incremental sensor 2624 when the incremental sensor 2624 faces the magnetic target 2616.

More particularly, the incremental sensor 2624 is between the magnetic target 2616 and the back-biasing magnet 2621. The incremental sensor 2624 can be a fixed pitch position sensor and can be located, together with the second substrate 2628 and the back-biasing magnet 2621, beyond the circumference 2622 of the magnetic target 2616 relative to the rotatable shaft.

The incremental sensor 2624 can be off-shaft sensors measuring in an axial direction of the rotatable shaft 2604, which should be understood as in line with the rotatable shaft 2604. The measurements made by the magnetic multi-turn sensor 2610 and the angle sensor 2608 provide a first level of resolution and precision. The signal output by the incremental sensor 2624 from the second magnetic field 2620 can then be used to provide a higher resolution measurement of the angular position for the rotatable shaft 2604.

The first substrate 2626 and the second substrate 2628 can be connected electrically with a bridge interconnect (not shown) extending therebetween. Around the magnet 2602 a shield 2632 is mounted and positioned. The shield 2632 can prevent cross field interactions between the first magnetic field 2612 and the second magnetic field 2620.

Furthermore, the shield 2632 can prevent the second magnetic field 2620 from the magnetic target 2612 from interfering, inducing noise, or false readings on the angle sensor 2608 and the magnetic multi-turn sensor 2610. Still further, the shield 2632 can prevent the first magnetic field 2612 from the magnet 2602 from interfering, inducing noise, or false readings on the incremental sensor 2624.

The first magnetic sensing device 2606 and the second magnetic sensing device 2615 can be coupled to a controller (not shown) for reading the angle sensor 2608, the magnetic multi-turn sensor 2610, and the incremental sensor 2624.

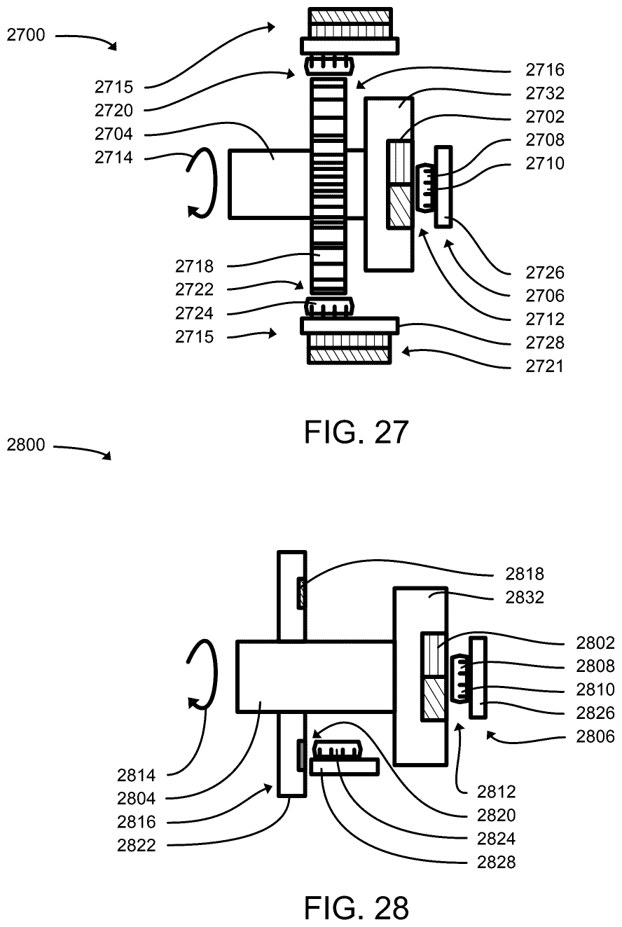

Referring now to FIG. 27, therein is shown a side view of the measurement system 2700 in a fifteenth embodiment. The measurement system 2700 can be a magnetic sensor system, comprising a magnet 2702 mounted on a rotatable shaft 2704.

The measurement system 2700 can further include a first magnetic sensing device 2706 configured to be in a vicinity of the magnet 2702, the first magnetic sensing device 2706 can comprise an angle sensor 2708 and a magnetic multi-turn sensor 2710. The angle sensor 2708 can be configured to detect an orientation of a first magnetic field 2712 generated by the magnet 2702 as the rotatable shaft 2704 is rotated.

The magnetic multi-turn sensor 2710 can be configured to detect a number of turns 2714 of the first magnetic field 2712 caused by the magnet 2702 rotating on the rotatable shaft 2704. Both the angle sensor 2708 and the magnetic multi-turn sensor 2710 are configured to read the first magnetic field 2712.

With both the magnetic multi-turn sensor 2710 and the angle sensor 2708 within the first magnetic sensing device 2706, a wide angle-range can be read and detected. For instance, the angle sensor 2708 can determine angles between 0 and 360 degrees, while the multi-turn sensor could, for example, count to 48 turns and provide a range of 48 times 360 degrees or 17280 degrees of measurement.

To increase the resolution and precision of the measurements of the first magnetic sensing device 2706, a second magnetic sensing device 2715 can be included. The second magnetic sensing device 2715 consists of a magnetic target 2716 or disk depicted as a soft magnetic gear.

The magnetic target 2716 can comprise at least one track 2718 for inducing a change in magnetic fields. The second magnetic sensing device 2715 can include two sensing modules. Each of the sensing modules can have independent magnetic fields created by back-biasing magnets assigned to each of the incremental sensors.

The tracks 2718 can be teeth of a soft magnetic gear, which generate magnetic repetitions as the magnetic target 2716 is rotated through incremental magnetic fields 2720 of the back-biasing magnets 2721. It is contemplated that the number of the teeth can be tailored to the specific application with more teeth providing a finer resolution.

The tracks 2718 can be formed on a circumference 2722 of the magnetic target 2716. The second magnetic sensing device 2715 can include incremental sensors 2724 configured to detect changes in the incremental magnetic fields 2720 induced by the tracks 2718 as they are rotated through the incremental magnetic fields 2720 of the back-biasing magnets 2721.

The incremental sensors 2724 can be represented as two off-shaft sensors placed 180 degrees apart radially relative to the shaft. Where more than one of the incremental sensors 2724 are used, they should be equally spaced radially about the shaft.

It has been discovered that including multiple incremental sensors 2724 increases redundancy, which allows the measurement system 2700 to continue to accurately measure angle even if one of the incremental sensors 2724 is offline. Furthermore, the multiple incremental sensors 2724 can increase accuracy of the measurement.

While the first magnetic sensing device 2706 can consist of a first substrate 2726 supporting and connecting the angle sensor 2708 and the magnetic multi-turn sensor 2710, the second magnetic sensing device 2715 can consist of a second substrate 2728 for supporting and connecting the incremental sensors 2724.

The incremental sensors 2724 and the back-biasing magnets 2721 can be on either side of the second substrate 2728. The back-biasing magnets 2721 can be behind the incremental sensors 2724 when the incremental sensors 2724 faces the magnetic target 2716.

More particularly, the incremental sensors 2724 are between the magnetic target 2716 and the back-biasing magnets 2721. The incremental sensors 2724 can be located beyond the circumference 2722 of the magnetic target 2716 relative to the rotatable shaft.

The incremental sensors 2724 can be off-shaft sensors measuring in an axial direction of the rotatable shaft 2704, which should be understood as in line with the rotatable shaft 2704. The measurements made by the magnetic multi-turn sensor 2710 and the angle sensor 2708 provide a first level of resolution and precision. The signal output by the incremental sensors 2724 from the incremental magnetic fields 2720 can then be used to provide a higher resolution measurement of the angular position for the rotatable shaft 2704.

The first substrate 2726 and the second substrate 2728 can be connected electrically with a bridge interconnect (not shown) extending therebetween. Around the magnet 2702 a shield 2732 is mounted and positioned. The shield 2732 can prevent cross field interactions between the first magnetic field 2712 and the incremental magnetic fields 2720.

Furthermore, the shield 2732 can prevent the incremental magnetic fields 2720 from the magnetic target 2712 from interfering, inducing noise, or false readings on the angle sensor 2708 and the magnetic multi-turn sensor 2710. Still further, the shield 2732 can prevent the first magnetic field 2712 from the magnet 2702 from interfering, inducing noise, or false readings on the incremental sensors 2724.

The first magnetic sensing device 2706 and the second magnetic sensing device 2715 can be coupled to a controller (not shown) for reading the angle sensor 2708, the magnetic multi-turn sensor 2710, and the incremental sensors 2724.

Referring now to FIG. 28, therein is shown a side view of the measurement system 2800 in a sixteenth embodiment. The measurement system 2800 can be a magnetic sensor system, comprising a magnet 2802 mounted on a rotatable shaft 2804.

The measurement system 2800 can further include a first magnetic sensing device 2806 configured to be in a vicinity of the magnet 2802, the first magnetic sensing device 2806 can comprise an angle sensor 2808 and a magnetic multi-turn sensor 2810. The angle sensor 2808 can be configured to detect an orientation of a first magnetic field 2812 generated by the magnet 2802 as the rotatable shaft 2804 is rotated.

The magnetic multi-turn sensor 2810 can be configured to detect a number of turns 2814 of the first magnetic field 2812 caused by the magnet 2802 rotating on the rotatable shaft 2804. Both the angle sensor 2808 and the magnetic multi-turn sensor 2810 are configured to read the first magnetic field 2812.

With both the magnetic multi-turn sensor 2810 and the angle sensor 2808 within the first magnetic sensing device 2806, a wide angle-range can be read and detected. For instance, the angle sensor 2808 can determine angles between 0 and 360 degrees, while the multi-turn sensor could, for example, count to 48 turns and provide a range of 48 times 360 degrees or 17280 degrees of measurement.

To increase the resolution and precision of the measurements of the first magnetic sensing device 2806, a second magnetic sensing device 2815 can be included. The second magnetic sensing device 2815 consists of a magnetic target 2816 or disk depicted as an active magnetic area.

The second magnetic sensing device 2815 can detect the magnetic field change caused by the magnetic target 2816 as it is rotated by the rotatable shaft 2804. The magnetic target 2816 can comprise at least one track 2818 for inducing a change in a second magnetic field 2820 generated by the magnetic target 2816.

The tracks 2818 can be magnetic areas formed as magnets embedded, printed, or deposited near and within a circumference 2822 of the magnetic target 2816 relative to the rotatable shaft 2804. The second magnetic sensing device 2815 can include an incremental sensor 2824 configured to detect changes in the second magnetic field 2820 induced by the tracks 2818 as the rotatable shaft 2804 is rotated. The incremental sensor 2824 can be an off-shaft sensor measuring in an axial direction of the rotatable shaft 2804, which should be understood as in line with the rotatable shaft 2804.

Together, the first magnetic sensing device 2806 and the second magnetic sensing device 2815 provide a higher level of precision and resolution. That is, the magnetic multi-turn sensor 2810 counts the number of turns 2814 of the magnet 2802 on the rotatable shaft 2804 from the first magnetic field 2812 while the angle sensor 2808 measures the absolute angle of the rotatable shaft 2804 from the first magnetic field 2812.

The measurements made by the magnetic multi-turn sensor 2810 and the angle sensor 2808 provide a first level of resolution and precision. The signal output by the incremental sensor 2824 from the second magnetic field 2820 can then be used to provide a higher resolution measurement of the angular position for the rotatable shaft 2804.

The second magnetic sensing device 2815, including the incremental sensor 2824, along with the first magnetic sensing device 2806, including the angle sensor 2808 and the magnetic multi-turn sensor 2810, can be mounted to substrates. The substrates can be printed circuit boards or other rigid structure for maintaining the position of the first magnetic sensing device 2806 and the second magnetic sensing device 2815 relative to the rotatable shaft 2804, the magnet 2802, and the magnetic target 2816.

The first magnetic sensing device 2806 can consist of a first substrate 2826 for supporting and connecting the angle sensor 2808 and the magnetic multi-turn sensor 2810. The second magnetic sensing device 2815 can consist of a second substrate 2828 for supporting and connecting the incremental sensor 2824.

The first substrate 2826 and the second substrate 2828 are connected electrically with a bridge interconnect (not shown) extending therebetween. An arrangement using printed circuit boards may not be needed. This arrangement could also be achieved using customized lead-frames, molded interconnect device, or other suitable technologies.

Around the magnet 2802 a shield 2832 is mounted and positioned. The shield 2832 can prevent cross field interactions between the first magnetic field 2812 and the second magnetic field 2820.

Furthermore, the shield 2832 can prevent the second magnetic field 2820 from the magnetic target 2812 from interfering, inducing noise, or false readings on the angle sensor 2808 and the magnetic multi-turn sensor 2810. Still further, the shield 2832 can prevent the first magnetic field 2812 from the magnet 2802 from interfering, inducing noise, or false readings on the incremental sensor 2824.

The first magnetic sensing device 2806 and the second magnetic sensing device 2815 can be coupled to a controller (not shown) for reading the angle sensor 2808, the magnetic multi-turn sensor 2810, and the incremental sensor 2824.

The incremental sensor 2824 can be a fixed pitch position sensor and can be located, together with the second substrate 2828, within the circumference 2822 of the magnetic target 2816 relative to the rotatable shaft 2804.

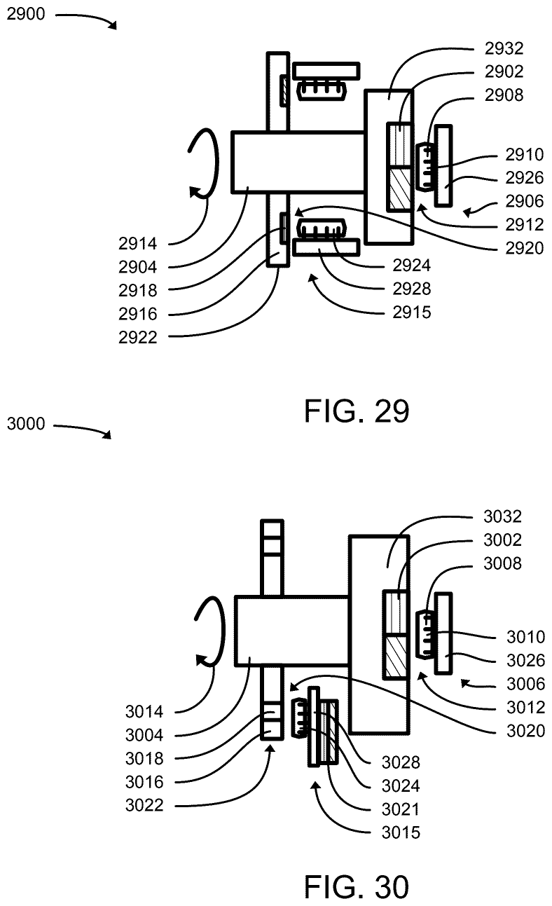

Referring now to FIG. 29, therein is shown a side view of the measurement system 2900 in a seventeenth embodiment. The measurement system 2900 can be a magnetic sensor system, comprising a magnet 2902 mounted on a rotatable shaft 2904.

The measurement system 2900 can further include a first magnetic sensing device 2906 configured to be in a vicinity of the magnet 2902, the first magnetic sensing device 2906 can comprise an angle sensor 2908 and a magnetic multi-turn sensor 2910. The angle sensor 2908 can be configured to detect an orientation of a first magnetic field 2912 generated by the magnet 2902 as the rotatable shaft 2904 is rotated.

The magnetic multi-turn sensor 2910 can be configured to detect a number of turns 2914 of the first magnetic field 2912 caused by the magnet 2902 rotating on the rotatable shaft 2904. Both the angle sensor 2908 and the magnetic multi-turn sensor 2910 are configured to read the first magnetic field 2912.

With both the magnetic multi-turn sensor 2910 and the angle sensor 2908 within the first magnetic sensing device 2906, a wide angle-range can be read and detected. For instance, the angle sensor 2908 can determine angles between 0 and 360 degrees, while the multi-turn sensor could, for example, count to 48 turns and provide a range of 48 times 360 degrees or 17280 degrees of measurement.

To increase the resolution and precision of the measurements of the first magnetic sensing device 2906, a second magnetic sensing device 2915 can be included. The second magnetic sensing device 2915 consists of a magnetic target 2916 or disk depicted as an active magnetic disc.

The second magnetic sensing device 2915 can detect the magnetic field change caused by the magnetic target 2916 as it is rotated by the rotatable shaft 2904. The magnetic target 2916 can comprise at least one track 2918 for inducing a change in a second magnetic field 2920 generated by the magnetic target 2916. The tracks 2918 can be magnetic areas formed as magnets embedded, printed, or deposited within a circumference 2922 of the magnetic target 2916 relative to the rotatable shaft 2904.

The second magnetic sensing device 2915 can include incremental sensors 2924 configured to detect changes in the second magnetic field 2920 induced by the tracks 2918 as the rotatable shaft 2904 is rotated. The incremental sensor 2924 can be off-shaft sensors measuring in an axial direction of the rotatable shaft 2904, which should be understood as in line with the rotatable shaft 2904.

The incremental sensors 2924 can be two off-shaft angle sensors offset by 180 degrees mechanically. It has been discovered that including multiple incremental sensors 2924 increases redundancy, which allows the measurement system 2900 to continue to accurately measure angle even if one of the incremental sensors 2924 is offline. Furthermore, the multiple incremental sensors 2924 can increase accuracy of the measurement.

Together, the first magnetic sensing device 2906 and the second magnetic sensing device 2915 provide a higher level of precision and resolution. That is, the magnetic multi-turn sensor 2910 counts the number of turns 2914 of the magnet 2902 on the rotatable shaft 2904 from the first magnetic field 2912 while the angle sensor 2908 measures the absolute angle of the rotatable shaft 2904 from the first magnetic field 2912.

The measurements made by the magnetic multi-turn sensor 2910 and the angle sensor 2908 provide a first level of resolution and precision. The signal output by the incremental sensors 2924 from the second magnetic field 2920 can then be used to provide a higher resolution measurement of the angular position for the rotatable shaft 2904.

The second magnetic sensing device 2915, including the incremental sensors 2924, along with the first magnetic sensing device 2906, including the angle sensor 2908 and the magnetic multi-turn sensor 2910, can be mounted to substrates. The substrates can be printed circuit boards or other rigid structure for maintaining the position of the first magnetic sensing device 2906 and the second magnetic sensing device 2915 relative to the rotatable shaft 2904, the magnet 2902, and the magnetic target 2916.

The first magnetic sensing device 2906 can consist of a first substrate 2926 for supporting and connecting the angle sensor 2908 and the magnetic multi-turn sensor 2910. The second magnetic sensing device 2915 can consist of a second substrate 2928 for supporting and connecting the incremental sensors 2924.

The first substrate 2926 and the second substrate 2928 are connected electrically with a bridge interconnect (not shown) extending therebetween. An arrangement using printed circuit boards may not be needed. This arrangement could also be achieved using customized lead-frames, molded interconnect device, or other suitable technologies.

Around the magnet 2902 a shield 2932 is mounted and positioned. The shield 2932 can prevent cross field interactions between the first magnetic field 2912 and the second magnetic field 2920.

Furthermore, the shield 2932 can prevent the second magnetic field 2920 from the magnetic target 2912 from interfering, inducing noise, or false readings on the angle sensor 2908 and the magnetic multi-turn sensor 2910. Still further, the shield 2932 can prevent the first magnetic field 2912 from the magnet 2902 from interfering, inducing noise, or false readings on the incremental sensors 2924.

The first magnetic sensing device 2906 and the second magnetic sensing device 2915 can be coupled to a controller (not shown) for reading the angle sensor 2908, the magnetic multi-turn sensor 2910, and the incremental sensor 2924. The incremental sensors 2924 can be located, together with the second substrate 2928, within the circumference 2922 of the magnetic target 2916 relative to the rotatable shaft 2904.

Referring now to FIG. 30, therein is shown a side view of the measurement system 3000 in an eighteenth embodiment. The measurement system 3000 can be a magnetic sensor system, comprising a magnet 3002 mounted on a rotatable shaft 3004.

The measurement system 3000 can further include a first magnetic sensing device 3006 configured to be in a vicinity of the magnet 3002, the first magnetic sensing device 3006 can comprise an angle sensor 3008 and a magnetic multi-turn sensor 3010. The angle sensor 3008 can be configured to detect an orientation of a first magnetic field 3012 generated by the magnet 3002 as the rotatable shaft 3004 is rotated.

The magnetic multi-turn sensor 3010 can be configured to detect a number of turns 3014 of the first magnetic field 3012 caused by the magnet 3002 rotating on the rotatable shaft 3004. Both the angle sensor 3008 and the magnetic multi-turn sensor 3010 are configured to read the first magnetic field 3012.

With both the magnetic multi-turn sensor 3010 and the angle sensor 3008 within the first magnetic sensing device 3006, a wide angle-range can be read and detected. For instance, the angle sensor 3008 can determine angles between 0 and 360 degrees, while the multi-turn sensor could, for example, count to 48 turns and provide a range of 48 times 360 degrees or 17280 degrees of measurement.

To increase the resolution and precision of the measurements of the first magnetic sensing device 3006, a second magnetic sensing device 3015 can be included. The second magnetic sensing device 3015 consists of a magnetic target 3016 or disk depicted as a passive magnetic disk.

The magnetic target 3016 can comprise at least one track 3018 for inducing a change in a second magnetic field 3020 generated by a back-biasing magnet 3021. The tracks 3018 can be holes or notches within the circumference 3022 of the magnetic target 3016, which generate magnetic repetitions as the magnetic target 3016 is rotated through the second magnetic field 3020 of the back-biasing magnet 3021.

It is contemplated that the number of the teeth can be tailored to the specific application with more teeth providing a finer resolution. The second magnetic sensing device 3015 can include an incremental sensor 3024 configured to detect changes in the second magnetic field 3020 induced by the tracks 3018 as they are rotated through the second magnetic field 3020 of the back-biasing magnet 3021.

While the first magnetic sensing device 3006 can consist of a first substrate 3026 supporting and connecting the angle sensor 3008 and the magnetic multi-turn sensor 3010, the second magnetic sensing device 3015 can consist of a second substrate 3028 for supporting and connecting the incremental sensor 3024.

The incremental sensor 3024 and the back-biasing magnet 3021 can be on either side of the second substrate 3028. The back-biasing magnet 3021 can be behind the incremental sensor 3024 when the incremental sensor 3024 faces the magnetic target 3016.

More particularly, the incremental sensor 3024 is between the magnetic target 3016 and the back-biasing magnet 3021. The incremental sensor 3024 can be a fixed pitch position sensor and can be located within the circumference 3022 of the magnetic target 3016 relative to the rotatable shaft 3004. The second substrate 3028 and the back-biasing magnet 3021, extending within and beyond the circumference 3022 of the magnetic target 3016 in relation to the rotatable shaft 3004.

The incremental sensor 3024 can be an off-shaft sensor measuring in an axial direction of the rotatable shaft 3004, which should be understood as in line with the rotatable shaft 3004. The measurements made by the magnetic multi-turn sensor 3010 and the angle sensor 3008 provide a first level of resolution and precision. The signal output by the incremental sensor 3024 from the second magnetic field 3020 can then be used to provide a higher resolution measurement of the angular position for the rotatable shaft 3004.

The first substrate 3026 and the second substrate 3028 can be connected electrically with a bridge interconnect (not shown) extending therebetween. Around the magnet 3002 a shield 3032 is mounted and positioned. The shield 3032 can prevent cross field interactions between the first magnetic field 3012 and the second magnetic field 3020.

Furthermore, the shield 3032 can prevent the second magnetic field 3020 from the magnetic target 3012 from interfering, inducing noise, or false readings on the angle sensor 3008 and the magnetic multi-turn sensor 3010. Still further, the shield 3032 can prevent the first magnetic field 3012 from the magnet 3002 from interfering, inducing noise, or false readings on the incremental sensor 3024.

The first magnetic sensing device 3006 and the second magnetic sensing device 3015 can be coupled to a controller (not shown) for reading the angle sensor 3008, the magnetic multi-turn sensor 3010, and the incremental sensor 3024.

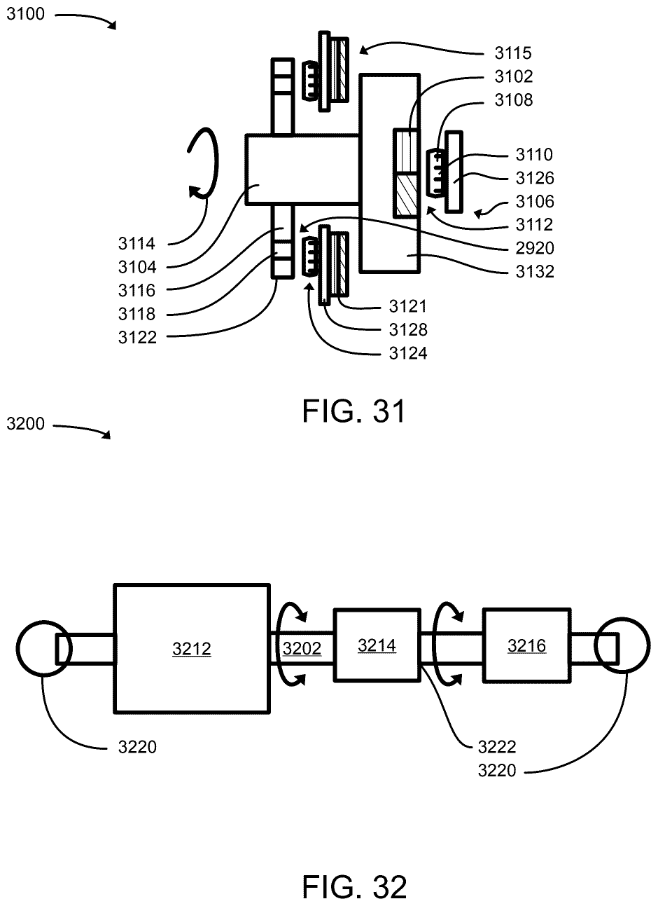

Referring now to FIG. 31, therein is shown a side view of the measurement system 3100 in a nineteenth embodiment. The measurement system 3100 can be a magnetic sensor system, comprising a magnet 3102 mounted on a rotatable shaft 3104.

The measurement system 3100 can further include a first magnetic sensing device 3106 configured to be in a vicinity of the magnet 3102, the first magnetic sensing device 3106 can comprise an angle sensor 3108 and a magnetic multi-turn sensor 3110. The angle sensor 3108 can be configured to detect an orientation of a first magnetic field 3112 generated by the magnet 3102 as the rotatable shaft 3104 is rotated.

The magnetic multi-turn sensor 3110 can be configured to detect a number of turns 3114 of the first magnetic field 3112 caused by the magnet 3102 rotating on the rotatable shaft 3104. Both the angle sensor 3108 and the magnetic multi-turn sensor 3110 are configured to read the first magnetic field 3112.

With both the magnetic multi-turn sensor 3110 and the angle sensor 3108 within the first magnetic sensing device 3106, a wide angle-range can be read and detected. For instance, the angle sensor 3108 can determine angles between 0 and 360 degrees, while the multi-turn sensor could, for example, count to 48 turns and provide a range of 48 times 360 degrees or 17280 degrees of measurement.

To increase the resolution and precision of the measurements of the first magnetic sensing device 3106, a second magnetic sensing device 3115 can be included. The second magnetic sensing device 3115 consists of a magnetic target 3116 or disk depicted as a passive magnetic disk.

The second magnetic sensing device 3115 can detect the magnetic field change caused by the magnetic target 3116 as it is rotated by the rotatable shaft 3104. The magnetic target 3116 can comprise at least one track 3118 for inducing a change in a second magnetic field 3120 generated by the magnetic target 3116.

The tracks 3118 can be formed within a circumference 3122 of the magnetic target 3116 as holes or notches within the magnetic target 3116. The second magnetic sensing device 3115 can include incremental sensors 3124 configured to detect changes in the second magnetic field 3120 induced by the tracks 3118 as the rotatable shaft 3104 is rotated.

The incremental sensors 3124 can be two off-shaft angle sensors offset by 180 degrees mechanically and measuring in an axial direction of the rotatable shaft 3104, which should be understood as in line with the rotatable shaft 3104. It has been discovered that including multiple incremental sensors 3124 increases redundancy, which allows the measurement system 3100 to continue to accurately measure angle even if one of the incremental sensors 3124 is offline. Furthermore, the multiple incremental sensors 3124 can increase accuracy of the measurement.

Together, the first magnetic sensing device 3106 and the second magnetic sensing device 3115 provide a higher level of precision and resolution. That is, the magnetic multi-turn sensor 3110 counts the number of turns 3114 of the magnet 3102 on the rotatable shaft 3104 from the first magnetic field 3112 while the angle sensor 3108 measures the absolute angle of the rotatable shaft 3104 from the first magnetic field 3112.

The measurements made by the magnetic multi-turn sensor 3110 and the angle sensor 3108 provide a first level of resolution and precision. The signal output by the incremental sensors 3124 from the second magnetic field 3120 can then be used to provide a higher resolution measurement of the angular position for the rotatable shaft 3104.

The second magnetic sensing device 3115, including the incremental sensors 3124, along with the first magnetic sensing device 3106, including the angle sensor 3108 and the magnetic multi-turn sensor 3110, can be mounted to substrates. The substrates can be printed circuit boards or other rigid structure for maintaining the position of the first magnetic sensing device 3106 and the second magnetic sensing device 3115 relative to the rotatable shaft 3104, the magnet 3102, and the magnetic target 3116.

The first magnetic sensing device 3106 can consist of a first substrate 3126 for supporting and connecting the angle sensor 3108 and the magnetic multi-turn sensor 3110. The second magnetic sensing device 3115 can consist of a second substrate 3128 for supporting and connecting the incremental sensors 3124.

The first substrate 3126 and the second substrate 3128 are connected electrically with a bridge interconnect (not shown) extending therebetween. An arrangement using printed circuit boards may not be needed. This arrangement could also be achieved using customized lead-frames, molded interconnect device, or other suitable technologies.

Around the magnet 3102 a shield 3132 is mounted and positioned. The shield 3132 can prevent cross field interactions between the first magnetic field 3112 and the second magnetic field 3120.

Furthermore, the shield 3132 can prevent the second magnetic field 3120 from the magnetic target 3112 from interfering, inducing noise, or false readings on the angle sensor 3108 and the magnetic multi-turn sensor 3110. Still further, the shield 3132 can prevent the first magnetic field 3112 from the magnet 3102 from interfering, inducing noise, or false readings on the incremental sensors 3124.

The first magnetic sensing device 3106 and the second magnetic sensing device 3115 can be coupled to a controller (not shown) for reading the angle sensor 3108, the magnetic multi-turn sensor 3110, and the incremental sensor 3124. The incremental sensors 3124 can be located within the circumference 3122 of the magnetic target 3116 relative to the rotatable shaft 3104. The second substrate 3128 and the back-biasing magnet 3121, extending within and beyond the circumference 3122 of the magnetic target 3116 in relation to the rotatable shaft 3104.

Referring now to FIG. 32, therein is shown a block diagram of the measurement system 3200 in a rotary application. The rotary application is shown having a rotatable shaft 3202.

Coupled to the rotatable shaft 3202 can be a motor 3212, an optional gear box 3214, and a load 3216. At either end 3220 of the rotatable shaft 3202, the measurement system 3200 can be coupled and can include the angle sensor, the magnetic multi-turn sensor, and the incremental sensor.

A rotary application is important where a precise angular measurement is needed on a rotating shaft while also tracking the number of rotations. The measurement system 3200 could be fixed to the motor 3212 directly, fixed to the rotatable shaft 3202, attached to the load 3216 or at the output 3222 of the optional gearbox 3214 among other possible use cases.

This measurement system 3200 can be integrated into a system anywhere there is an exposed end of shaft that is to be measured for angular position. Possible locations for placement of the measurement system in a purely rotational system are circled in red.

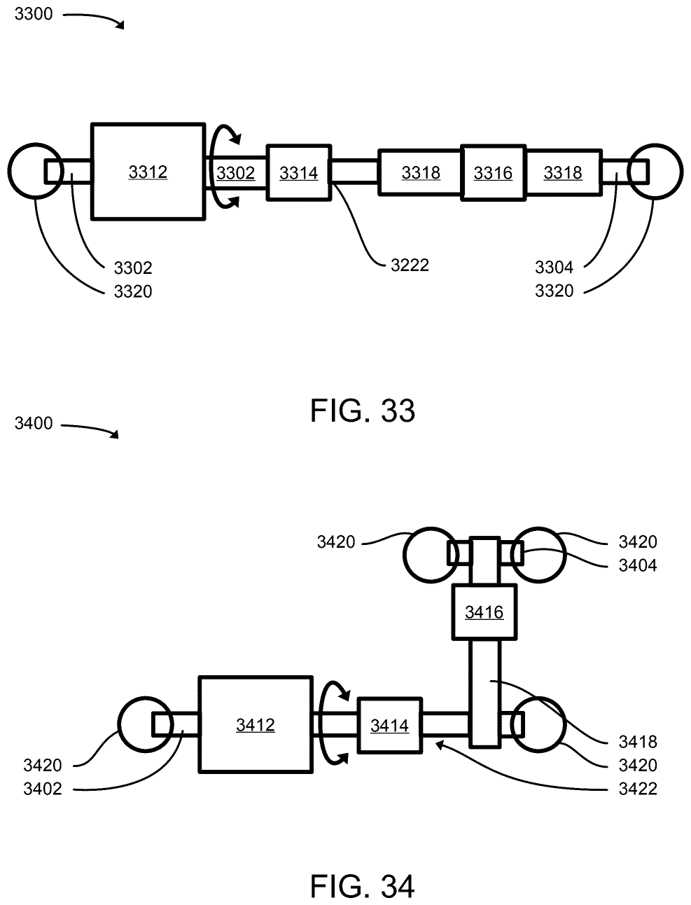

Referring now to FIG. 33, therein is shown a block diagram of the measurement system 3300 in a first rotary to linear application. The rotary to linear application is shown having a first rotatable shaft 3302 and a second rotatable shaft 3304.

Coupled to the first rotatable shaft 3302 can be a motor 3312, an optional gear box 3314, and a load 3316. The load 3316 can be coupled between the first rotatable shaft 3302 and the second rotatable shaft 3304 on a lead-screw 3318. At either end 3320 of the first rotatable shaft 3302 or the second rotatable shaft 3304, the measurement system 3300 can be coupled and can include the angle sensor, the magnetic multi-turn sensor, and the incremental sensor.

Rotary to linear movement can be measured by tracking the movement of the rotating shaft and inferring the linear movement of the system based on a fixed translation of the movement such as in lead screw or belt driven systems. A rotary to linear application is important where a precise linear distances must be inferred. The measurement system 3300 could be fixed to the motor 3312 directly, fixed to the first rotatable shaft 3302, fixed to the second rotatable shaft 3304, attached to the load 3316, or attached to an output 3322 of the optional gearbox 3314 among other possible use cases.

This measurement system 3300 can be integrated into a system anywhere there is an exposed end of shaft that is to be measured for angular position. Possible locations for the placement of the measurement system in a rotary to linear system are circled in red.

Referring now to FIG. 34, therein is shown a block diagram of the measurement system 3400 in a second rotary to linear application. The rotary to linear application is shown having a first rotatable shaft 3402, a second rotatable shaft 3404.

Coupled to the first rotatable shaft 3402 can be a motor 3412, an optional gear box 3414, and a load 3416. The load 3416 can be coupled between the first rotatable shaft 3402 and the second rotatable shaft 3404 on a conveyor belt 3418. At either end 3420 of the first rotatable shaft 3402 or the second rotatable shaft 3404, the measurement system 3400 can be coupled and can include the angle sensor, the magnetic multi-turn sensor, and the incremental sensor.

Rotary to linear movement can be measured by tracking the movement of the rotating shaft and inferring the linear movement of the system based on a fixed translation of the movement such as in lead screw or belt driven systems. A rotary to linear application is important where a precise linear distances must be inferred.

The measurement system 3400 could be fixed to the motor 3412 directly, fixed to the first rotatable shaft 3402, fixed to the second rotatable shaft 3404, attached to the load 3416, or attached to an output 3422 of the optional gearbox 3414 among other possible use cases. This measurement system 3400 can be integrated into a system anywhere there is an exposed end of shaft that is to be measured for angular position. Possible locations for the placement of the measurement system in a rotary to linear system are circled in red.

Rotary to linear movement is a possible use case for the measurement system. Two common types of rotary to linear systems are shown in FIGS. 33 and 34 but others exist that could integrate the measurement system for measurement of rotational movement. For example, other applications for the measurement system can include: cam mechanisms, rack and pinions systems, and ball screw systems.

Robotic systems can greatly benefit from the measurement system. Position feedback information is essential in robotic systems for precise control of arms, joints, and end effectors across many types of robotic platforms. The measurement system can provide precision angle measurements over multiple rotations to a control system to ensure accurate movements and positioning. And can recover without rehoming after a power down situation.

Industrial automation can greatly benefit from the measurement system. Industrial automation relies heavily on the deployment of various types of motors for the control of conveyor belts, assembly line components among other machinery. These often require precise movements using closed loop motors which in turn rely on a precise feedback system. This arrangement can provide such motion control feedback to a controller by delivering precision angle measurements over multiple rotations. And can recover without rehoming after a power down situation.

Motion control systems can greatly benefit from the measurement system. Fabrication and production utilize closed loop motor control for precise movement applications such as printing, packaging, and semiconductor manufacturing. Medical equipment such as MRI machines, robotic surgery systems, and patient positioning systems also rely on precise control feedback. The measurement system could provide a solution in these end applications, and can recover without rehoming after a power down situation.

Aerospace and defense can greatly benefit from the measurement system. This measurement system could provide a precise angle feedback in applications such as flight control surface positioning, control of weapons systems and antenna positioning in satellite platforms.

CNC machines can greatly benefit from the measurement system. Rotary to linear systems are common in CNC machines, 3D printers, and across many forms of tooling and machining processes. This measurement system could be utilized in the closed loop control of these rotary to linear or purely rotary motion control applications.

Automotive can greatly benefit from the measurement system. In automotive applications there are several use cases that could possibly integrate the measurement system outlined in this document. Classic steering applications utilize a rack and pinion type rotary to linear system. The trend towards steer-by-wire steering systems also opens up opportunities for design in of this measurement system with a need for precise closed loop control of the drive motors for the steering system. Other rotary actuators in the door and window systems could also integrate this measurement system.

Industrial or agricultural machinery can greatly benefit from the measurement system. Large machinery such as cranes, lifts, pulleys, and winches may have safety critical requirements that necessitate the inclusion of both a precision angle measurement and a powerless turn count sensor. Such applications may benefit from the adaptation of the measurement system outlined in this document.

Angle encoders can greatly benefit from the measurement system. Angle encoders are devices that measure the rotational position of a shaft or load relative to a shaft. These encoders rely on the precise measurement of angle and in many cases the counting of multiple rotations. The measurement system outlined in this document could be incorporated into an angle encoder solution to allow for this precise angle measurement with powerless turn count capabilities.

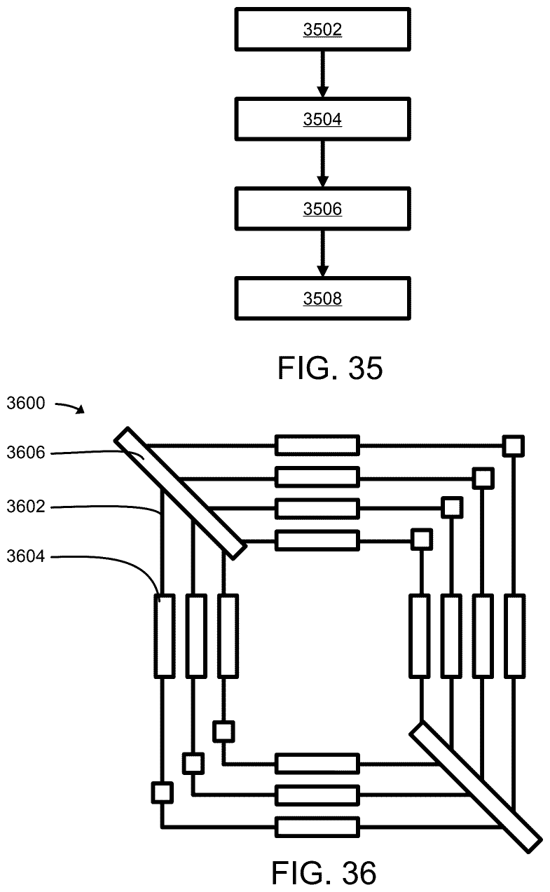

Referring now to FIG. 35, therein is shown a control flow for manufacturing the measurement system. The method of manufacturing can include providing a magnet mounted on a rotatable shaft in a block 3502; mounting a first magnetic sensing device in a vicinity of the magnet for detecting a first magnetic field from the magnet, the first magnetic sensing device comprising: an angle sensor configured to detect an orientation of the first magnetic field and a magnetic multi-turn sensor configured to detect a number of turns of the first magnetic field in a block 3504; mounting a second magnetic sensing device comprising a magnetic target mounted on the rotatable shaft and an incremental sensor configured to detect a second magnetic field, the magnetic target comprises a track for inducing a change in the second magnetic field in a block 3506; and positioning a shield between the magnet and the magnetic target in a block 3508.

Referring now to FIG. 36, therein is shown a magnetic multi-turn sensor 3600 for an embodiment of the measurement system. The magnetic multi-turn sensor 3600 can include a magnetic strip 3602.

The magnetic strip 3602 can be a GMR based magnetoresistive track that is physically laid out in a spiral configuration. The magnetic strip 3602 can be a conductive wire and have a plurality of segments formed of magnetoresistive elements 3604 arranged in series with each other and having the magnetic strip 3602 therebetween.

The magnetoresistive elements 3604 act as variable resisters that change resistance in response to a magnetic alignment state. The end of the magnetic strip 3602 is coupled to a domain wall generator 3606.

The domain wall generator 3606 may be coupled to either end of the magnetic strip 3602. The domain wall generator 3606 generates domain walls in response to rotations in an external magnetic field such as the first magnetic field 112 of FIG. 1 from the rotation of the magnet 102 of FIG. 1.

The domain walls are magnetic alignments that can be captured within the magnetoresistive elements 3604 whether the magnetic multi-turn sensor 3600 is in a power on condition or in a power off condition. The domain walls will propagate up through the magnetic strip 3602 down through the magnetic strip 3602 based on whether the magnet 102 is turning one direction or the other.

The number of turns performed by the magnet 102 can be recorded in the magnetoresistive elements 3604 in a power on condition and the magnetoresistive elements 3604 can continue to record the number of turns performed by the magnet 102 in a power off condition. Once the magnetic multi-turn sensor 3600 is powered on, the magnetoresistive elements 3604 can be read and the number of turns performed during the power off condition will be determined.

Thus, it has been discovered that the measurement system furnishes important and heretofore unknown and unavailable solutions, capabilities, and functional aspects. The resulting configurations are straightforward, cost-effective, uncomplicated, highly versatile, accurate, sensitive, and effective, and can be implemented by adapting known components for ready, efficient, and economical manufacturing, application, and utilization.

This measurement system provides an arrangement to measure the mechanical angle of a shaft. The measurement system combines multiple magnetic sensors to provide an angle information measured at the end of a shaft, a turn count information measured at the end of a shaft as well and a precise incremental angle information measured off-shaft. This combination allows to measure precise angles and includes the capability of counting turns without electrical power to go beyond 0 to 360 degree measurement.

While the measurement system has been described in conjunction with a specific best mode, it is to be understood that many alternatives, modifications, and variations will be apparent to those skilled in the art in light of the preceding description. Accordingly, it is intended to embrace all such alternatives, modifications, and variations, which fall within the scope of the included claims. All matters set forth herein or shown in the accompanying drawings are to be interpreted in an illustrative and non-limiting sense.

What is claimed is:

1. A measurement system comprising:
a magnet mounted on a rotatable shaft;
a first magnetic sensing device for detecting a first magnetic field from the magnet, the first magnetic sensing device comprising: an angle sensor configured to detect an orientation of the first magnetic field and a magnetic multi-turn sensor configured to detect a number of turns of the first magnetic field; and
a second magnetic sensing device comprising a magnetic target mounted on the rotatable shaft and an incremental sensor configured to detect a second magnetic field, the magnetic target comprises a track for inducing a change in the second magnetic field.

2. The system of claim 1 wherein: the magnetic multi-turn sensor is configured to continue to record the number of turns in a powered off condition.

3. The system of claim 1 wherein: the track of the magnetic target is a hole, a notch, or a tooth; and
further comprising: a back-biasing magnet providing the second magnetic field.

4. The system of claim 1 wherein: the track of the magnetic target is an active magnetic area on the magnetic target.

5. The system of claim 1 further comprising: a mold compound coupling the magnet and the magnetic target.

6. A measurement system comprising:
a magnet mounted on a rotatable shaft;
a first magnetic sensing device for detecting a first magnetic field from the magnet, the first magnetic sensing device comprising: an angle sensor configured to detect an orientation of the first magnetic field and a magnetic multi-turn sensor configured to detect a number of turns of the first magnetic field;
a second magnetic sensing device comprising a magnetic target mounted on the rotatable shaft and an incremental sensor configured to detect a second magnetic field, the magnetic target comprises a track for inducing a change in the second magnetic field; and
a shield positioned between the magnet and the magnetic target.

7. The system of claim 6 wherein: the magnet is within a center of the magnetic target.

8. The system of claim 6 wherein: the incremental sensor is mounted beyond a circumference of the magnetic target.

9. The system of claim 6 wherein:
the incremental sensor is a first incremental sensor; and
the second magnetic sensing device includes a second incremental sensor positioned at an even angular distance from the first incremental sensor.

10. The system of claim 6 further comprising: a motor coupled to the rotatable shaft.

11. A method of manufacturing a measurement system comprising:
providing a magnet mounted on a rotatable shaft;
mounting a first magnetic sensing device for detecting a first magnetic field from the magnet, the first magnetic sensing device comprising: an angle sensor configured to detect an orientation of the first magnetic field and a magnetic multi-turn sensor configured to detect a number of turns of the first magnetic field; and
mounting a second magnetic sensing device comprising a magnetic target mounted on the rotatable shaft and an incremental sensor configured to detect a second magnetic field, the magnetic target comprises a track for inducing a change in the second magnetic field.

12. The method of claim 11 wherein: configuring the first magnetic sensing device includes configuring the first magnetic sensing device with the magnetic multi-turn sensor configured to continue to record the number of turns in a powered off condition.

13. The method of claim 11 wherein:
mounting the second magnetic sensing device includes mounting the second magnetic sensing device with the track of the magnetic target being a hole, a notch, or a tooth; and
mounting the second magnetic sensing device includes positioning a back-biasing magnet for providing the second magnetic field.

14. The method of claim 11 wherein: mounting the second magnetic sensing device includes mounting the second magnetic sensing device with the track of the magnetic target being an active magnetic area on the magnetic target.

15. The method of claim 11 further comprising: forming a mold compound coupling the magnet and the magnetic target.

16. The method of claim 11 further comprising: positioning a shield between the magnet and the magnetic target.

17. The method of claim 16 wherein: mounting the magnet includes mounting the magnet within a center of the magnetic target.

18. The method of claim 16 wherein: mounting the second magnetic sensing device including the incremental sensor includes mounting the incremental sensor beyond a circumference of the magnetic target.

19. The method of claim 16 wherein:
mounting the second magnetic sensing device including the incremental sensor includes mounting the incremental sensor as a first incremental sensor; and
mounting the second magnetic sensing device includes mounting a second incremental sensor positioned at an even angular distance from the first incremental sensor.

20. The method of claim 16 further comprising: coupling a motor to the rotatable shaft.
